(19) United States
(12) Patent Application Publication
(10) Pub. No.: US 2024/0400405 A1
(43) Pub. Date: Dec. 5, 2024

(54) Processes for Producing Reactant Chemical Substances

(71) Applicant: Alpha Portfolio LLC, Naples, FL (US)

(72) Inventors: Addison FISCHER, Naples, FL (US); Christopher J. NAGEL, Wayland, MA (US)

(21) Appl. No.: 18/802,297

(22) Filed: Aug. 13, 2024

Related U.S. Application Data
(63) Continuation of application No. PCT/US2022/018510, filed on Mar. 2, 2022.

(51) Int. Cl. C01F 11/02

(52) U.S. Cl. CPC C01F 11/02; C01P 2002/08; C01P 2006/80

(57) ABSTRACT

The invention includes apparatus and methods for instantiating chemical reactants, including elemental metals such as calcium in a nanoporous carbon powder, and forming products therefrom, such as calcium oxide and calcium hydroxide.

### RELATED APPLICATION

This application is a continuation of International Application No. PCT/US22/18510, which designated the United States and was filed on Mar. 2, 2022, published in English. The entire teachings of the above application are incorporated herein by reference.

### BACKGROUND OF THE INVENTION

Calcium oxide (CaO, also known as quicklime) and calcium hydroxide (Ca(OH)₂, also known as slaked lime or hydrated lime) have numerous industrial applications. CaO is used to form the clinker that acts as the binder material in Portland cement; cement, mixed with sand, gravel and water, forms concrete, the most widely used construction material in the world, with over 4.5 billion tons of cement produced each year. However, the production of CaO and Ca(OH)₂ generates significant amounts of CO₂, imposing significant stresses on the environment. Cement production is currently the largest industrial emitter of CO₂ emissions worldwide, accounting for about 8% (2.7 billion tons) of CO₂ per year due to its reliance on CaO production.

CaO is typically made by heating calcium carbonate (CaCO₃ also known as calcite) at a temperature greater than about 825° C., a process known as calcination. Calcination proceeds as shown in the following equation (EQ1):

$${CaCO}_{3} ( s ) + heat \to CaO ( s ) + {CO}_{2} ( g ) \qquad EQ1$$

As shown in EQ1, the calcination reaction itself generates CO₂, but since the reaction is endothermic, it involves additional generation of CO₂ if conventional combustion processes are used to produce the necessary heat for the reaction. In most industrial calcination settings, some sort of fossil fuel combustion is used to heat the CaCO₃ to the temperature required to produce CaO. The CO₂ generated by the calcination process can be discharged in the flue gas along with the CO₂ produced by fuel combustion that provides heat for the calcination reaction. These two streams of CO₂ in the flue gas mix with atmospheric nitrogen, making it more difficult to capture the CO₂ from the exhaust to reduce its environmental impact.

In addition to its use for forming cement, CaO is the feedstock for Ca(OH)₂, according to the following equation (EQ2):

$$CaO + {H}_{2} O \to {Ca ( OH )}_{2} \qquad EQ2$$

Because Ca(OH)₂ is derived from CaO, industrial processes using Ca(OH)₂ as feedstock secondarily entail the release of CO₂ into the atmosphere: Ca(OH)₂ requires CaO as feedstock, and CaO production involves significant CO₂ generation. Because it is derived from CaO, Ca(OH)₂ shares responsibility for adding to the atmosphere's CO₂ burden. With increasing global awareness of the deleterious effects of CO₂ on the environment, there is a greater demand for processes that reduce the production and emission of CO₂. While mitigating procedures have been incorporated into various industrial sectors that rely on CaO, including the cement production sector, the amount of CO₂ emissions from calcination remains high. There remains a need in the art for an alternative to calcination for producing CaO in a way that is energy-efficient without producing CO₂.

### SUMMARY OF THE INVENTION

In embodiments, the present invention relates to the discovery that apparatuses containing carbon matrices can be used to produce chemical reactants useful as chemical feedstocks. The processes of the invention include the application of electromagnetic radiation, directly and/or indirectly, to gases, nano-porous carbon, or compositions and combinations thereof, thereby pre-treating the gas, and exposing a carbon matrix to pre-treated gas in an apparatus of the invention and recovering those reactant chemicals produced therein. In embodiments, the present invention relates to methods of instantiating materials in nanoporous carbon matrices, for example to form elemental metal nuggets, nano nuggets, nanowires, and other macrostructures, microstructures, and nanostructures, and apparatuses adapted for the methods.

Advantageously, these apparatuses and processes can be used for the production of chemical feedstocks that are elemental metals such as Ca and its derivatives, including oxides and hydroxides. Such metals include but are not limited to alkali metals (e.g., Li, Na, K, etc.) and alkaline earth metals (e.g., Ca, Ba, etc.). In some embodiments, this invention can be advantageously used when the elemental metal such as calcium is not readily accessible in nature, for example, due to its high reactivity. In some embodiments, a system may produce the elemental metal (e.g., Ca) to be used as a chemical reactant, and then react it with oxygen to yield a corresponding chemical reaction product such as metal oxide (e.g., CaO). In embodiments, the oxygen as well as the primary chemical reactant (e.g., Ca) can be instantiated, or filtered, or isolated, or extracted, or nucleated, by apparatuses and methods according to the invention.

In embodiments, a compound molecule in its entirety, for example and without limitation, CaO can be instantiated, filtered, isolated, extracted, or nucleated, by apparatuses and methods according to the invention—thus obviating need for a subsequent chemical reaction to combine them.

In embodiments, the inventive systems can be configured in a way suitable for industrial production of the metal oxide (e.g., CaO). For example, the elemental metal can be produced in batches or in a continuous fashion within the system, and then can be reacted with oxygen, which can be produced within the system in batches or in a continuous fashion or supplied from other sources. Optionally, the metal oxide (e.g., CaO) can be subsequently converted into other desired derivatives such as hydroxides.

The invention relates to apparatuses for instantiating materials, and processes for using such apparatuses. The invention includes processes comprising the steps of contacting a bed comprising nanoporous carbon with an activated gas while applying electromagnetic radiation to the nanoporous carbon for a time sufficient to cause instantiation of the chemical reactant, including but not limited to nucleation, growth deposition and/or agglomeration, of elemental metal nanoparticles within and/or from carbon nanopores and nano-pore networks and matrices, and collecting the chemical reactant and/or using it for other chemical reactions.

In embodiments, the inventive processes results in nanoporous carbon compositions or matrices characterized by elemental metals deposited within carbon nanopores and agglomerated elemental nanoparticles, creating elemental metal nuggets, micronuggets, nanonuggets, nanowires and other macrostructures that can be easily separated from the nanoporous carbon. The processes of the invention have broad applicability in producing elemental metal composition and micro-, nano- and macro-structures. The invention further relates to the nanoporous carbon compositions, elemental metal nanoparticles and elemental macrostructures produced by the methods of the invention. The invention further relates to the chemical reactant, including an elemental metal, produced by the inventive processes.

More specifically, the invention includes a process of instantiating a chemical reactant, including an elemental metal, within a nanoporous carbon powder comprising the steps of:
(i) adding a nanoporous carbon powder into a reactor assembly (RA), as described below,
(ii) adding a feedgas composition to the reactor assembly, wherein the feedgas composition is free of the desired chemical reactant, for example, adding a feedgas free of metal salts and vaporized metals to the reactor assembly;
(iii) powering one or more RA coils to a first electromagnetic energy level;
(iv) subjecting the nanoporous carbon powder (the terms nanoporous carbon powder, nanoporous carbon material and nanoporous carbon are used herein interchangeably) to harmonic patterning to instantiate the chemical reactant in product compositions, for example to deposit elemental metal (e.g., calcium) nanostructures;
(v) collecting the product compositions comprising the chemical reactant; and
(vi) optionally isolating the chemical reactant from the product compositions.

In one embodiment, the RA coil surrounds a nanoporous carbon bed to establish a harmonic electromagnetic resonance in ultramicropores of the nanoporous carbon powder, or in other embodiments in other pores. The feedgas composition can be, for example, air, oxygen, hydrogen, helium, nitrogen, neon, argon, krypton, xenon, carbon monoxide, carbon dioxide or mixtures thereof. Preferably, the nanoporous carbon powder comprises graphene having at least 99.9% wt. carbon (metals basis), a mass mean diameter between 1 μm and 5 mm, and an ultramicropore surface area between about 100 and 3000 m²/g.

In embodiments, the process deposits metal (e.g., calcium) atoms in a plurality of discrete rows on the nanoporous carbon powder, thereby forming a carbon-metal interface, which can be sp² carbon. The ordered nano-deposit array can comprise discrete rows of nano-deposits, wherein the nano-deposits are characterized by a diameter of between about 0.1 and 0.3 nm, and the space between copper deposit rows is less than about 1 nm. The ordered nano-deposit array can be characterized by a carbon rich area and a calcium rich area adjacent to the array and the discrete rows can be spaced to form a gradient.

More specifically, the invention includes a reactor assembly comprising:
(i) A reactor chamber containing a nanoporous carbon material;
(ii) A second porous frit defining the ceiling of the reactor chamber; wherein each porous frit has a porosity that is sufficient to allow a gas to permeate into the reactor chamber and contain a nanoporous carbon material;
(iii) A reactor head space disposed above the reactor cap;
(iv) 1, 2, 3, 4, 5 or more RA coils surrounding the reactor chamber and/or reactor head space operably connected to one or more RA frequency generators and/or one or more power supplies;
(v) 0, 1, 2, 3, 4, 5 or more pairs of RA lamps wherein the pairs of RA lamps are disposed circumferentially around the RA coils and define a space between the pairs of RA lamps and the RA coils, when present;
(vi) An optional x-ray source configured to expose the reactor chamber to x-rays;
(vii) One or more optional lasers configured to direct a laser towards (e.g., through or across) the reactor chamber or the gas within the reactor assembly, when present; and
(viii) A computer processing unit (CPU) configured to control the power supply, frequency generator, x-ray source, lamps and/or lasers.

As will be described in more detail below, the gas inlet of the reactor assembly can be in fluid connection with at least one gas supply selected from the group consisting, without limitation, of air, oxygen, hydrogen, helium, nitrogen, neon, argon, krypton, xenon, carbon monoxide, carbon dioxide and mixtures thereof, wherein the gas supply is free of metal salts and vaporized metals; and/or (iii) the gas supply is directed through a gas manifold controlled by mass flow meters.

As will be described in more detail below, the nanoporous carbon powder charged to the reactor assembly can comprise graphene having at least 95% wt. carbon (metals basis), a mass mean diameter between 1 μm and 5 mm, and an ultramicropore surface area between about 100 and 3000 m²/g. The nanoporous carbon powder is preferably characterized by acid conditioning, wherein the acid is selected from the group consisting, without limitation, of HCl, HF, HBr, HI, sulfuric acid, phosphoric acid, carbonic acid, and nitric acid, and a residual water content of less than that achieved upon exposure to a relative humidity (RH) of less than 40% RH at room temperature. In a preferred embodiment, the process contemplates degassing the nanoporous carbon powder prior to the process.

As will be described in more detail below, the reactor assembly can include a plurality of devices that can impart electromagnetic fields, including x-ray sources, coils, lasers and lamps or lights, including pencil lamps, short wave and long wave lamps. The wavelengths generated by each device (e.g., lamps or lasers) can be independently selected.

As will be described in more detail below, the RA coils can be made from the same or different electrically conducting materials. For example, a first RA coil comprises a copper wire winding, a second RA coil comprises a braiding of copper wire and silver wire, and a third RA coil is a platinum wire winding, and each RA coil is configured to create a magnetic field and wherein each power supply independently provides AC and/or DC current.

As will be described in more detail below, the reactor assembly can be characterized by (i) a first pair of RA lamps configured in a first plane defined by a center axis and a first radius of the reactor chamber, (ii) a second pair of RA lamps configured in a second plane defined by the center axis and a second radius of the reactor chamber and (iii) a third pair of RA lamps configured in a third plane defined by the center axis and a third radius of the reactor chamber. Preferably, each RA lamp is a pencil lamp characterized by a tip substantially equidistant from the central axis and each pair of RA lamps comprises a vertical RA lamp and a horizontal RA lamp. Preferably each pair of lamps is equidistantly spaced around the circumference of the reactor chamber.

As will be described in more detail below, the reactor assembly further comprises an electromagnetic embedding enclosure (E/MEE or EMEE), as defined more specifically below. The E/MEE is typically located along a gas line upstream of the reactor assembly gas inlet. Typically, an electromagnetic embedding enclosure located upstream of the gas inlet comprises:
(a) a gas inlet; and
(b) at least one E/MEE pencil lamp positioned below the internal gas line, at least one E/MEE pencil lamp positioned above the internal gas line and at least one E/MEE pencil lamp positioned to the side of the internal gas line;
wherein each E/MEE pencil lamp is independently rotatably mounted, located along the length of the internal gas line, and the lamps and/or coil(s) are powered by a power supply, preferably the power supply of the reactor assembly; and the gas flow, lamps and/or coil(s) are preferably independently controlled by one or more central processing units, preferably the central processing unit (CPU) of the reactor assembly.

Typically, a CPU independently controls powering each E/MEE pencil lamp and a rotation position of each E/MEE pencil lamp.

As will be described in more detail below, the E/MEE housing can be typically closed and opaque, the internal gas line can be transparent and external gas line in fluid connection with the housing outlet and gas inlet can be opaque. Typically, the internal gas line is between 50 cm and 5 meters or more and has a diameter between 2 mm and 25 cm or more.

As will be described in more detail below, the apparatus can have at least 5 E/MEE pencil lamps located along the internal gas line. Each E/MEE pencil lamp can be independently placed such that its longitudinal axis is (i) parallel to the internal gas line, (ii) disposed radially in a vertical plane to the internal gas line, or (iii) perpendicular to the plane created along the longitudinal axis of the internal gas line or along the vertical axis of the internal gas line. Each E/MEE pencil lamp can be independently affixed to one or more pivots that permit rotation, such as, between about 0 and 360 degrees (such as, between about 0 and 90 degrees, between about 0 and 180 degrees, between about 0 and 270 degrees and any angle therebetween) with respect to the x, y, and/or z axis wherein (i) the x-axis is defined as the axis parallel to the gas line and its vertical plane, (ii) the y-axis defining the axis perpendicular to the gas line and parallel to its horizontal plane, and (iii) the z-axis is defined as the axis perpendicular to the gas line and parallel to its vertical plane.

As will be described in more detail below, at least one E/MEE pencil lamp can be a neon lamp, at least one E/MEE pencil lamp can be a krypton lamp, and at least one E/MEE pencil lamp can be an argon lamp. It can be desirable to match, or pair, one or more E/MEE pencil lamps with one or more (e.g., a pair) of RA lamps. Accordingly, at least one pair of RA pencil lamps can be selected from the group consisting of a neon lamp, a krypton lamp and an argon lamp.

As will be described in more detail below, the invention includes a process of producing a nanoporous carbon composition comprising the steps of: (a) initiating a gas flow in a reactor assembly as described herein; (b) independently powering each RA coil to a first electromagnetic energy level; (c) powering the one or more RA frequency generators and applying a frequency to each RA coil; (d) independently powering each RA lamp; (e) independently powering each laser; (f) powering the x-ray source; and (g) subjecting the nanoporous carbon powder to harmonic electromagnetic resonance in ultramicropores of the nanoporous carbon powder to instantiate a fluid (preferably gaseous) or solid chemical reactant (e.g., an elemental metal nanostructure such as calcium) in a nanopore.

As will be described in more detail below, the invention also includes nanoporous carbon powder compositions, and fluid compositions (preferably gases) produced in accordance with the claimed methods and processes. The invention also includes a process of instantiating a fluid (preferably gaseous) or solid chemical reactant (e.g., an elemental metal nanostructure such as calcium) within an ultramicropore of a nanoporous carbon powder comprising the steps of: (a) initiating a gas flow in a reactor assembly further comprising an E/MEE, as described herein; (b) independently powering each RA coil to a first electromagnetic energy level; (c) powering the one or more RA frequency generators and applying a frequency to each RA coil; (d) independently powering each RA lamp; (c) independently powering each laser; (f) powering the x-ray source; and (g) subjecting the nanoporous carbon powder to harmonic electromagnetic resonance in ultramicropores of the nanoporous carbon powder to instantiate the fluid (preferably gaseous) or solid chemical reactant (e.g., an elemental metal nanostructure such as calcium) in a nanopore. The invention further includes a fluid (preferably gaseous) or solid chemical reactant by the aforesaid process. It is to be understood that the term “independently” is not meant to be absolute but is used to optimize results. Rather, controlling each RA coil, lamp and/or laser (each a device) such that it is powered (or rotated) at the same time or at a time specified before and/or after another device is meant to be “independently” controlled. Thus, assigning two or more devices to a power supply and control unit in series is contemplated by the term. The term is intended to exclude simply powering (or rotating) all devices simultaneously.

In one aspect, the invention can include a process for producing a chemical reactant (e.g., an elemental metal such as calcium), comprising the steps of:
(a) Adding a feed gas to an electromagnetic embedding apparatus comprising:
   (i) a gas line containing the feed gas,
   (ii) at least one E/MEE pencil lamp positioned below the gas line,
   (iii) at least one E/MEE pencil lamp positioned above the gas line and
   (iv) at least one E/MEE pencil lamp positioned to the side of the gas line, wherein each E/MEE pencil lamp is independently rotatably mounted, located along the length of the gas line;
   (v) a power source operably connected to each pencil lamp, and
   (vi) a central processing unit configured to independently control powering each E/MEE pencil lamp and a rotation position of each E/MEE pencil lamp;
(b) powering each pencil lamp, thereby subjecting the feed gas to electromagnetic radiation; optionally rotating one or more lamps;
(c) directing the feed gas from step (b) to a reactor assembly comprising:
   (i) a gas inlet and one or more gas outlets,
   (ii) a reactor chamber containing a nanoporous carbon disposed within a cup and, optionally, covered with a cap,
   (iii) a first porous frit defining a floor of the reactor chamber disposed within the cup,
   (iv) a second porous frit defining the ceiling of the reactor chamber and disposed below the cap; wherein each porous frit has a porosity that is sufficient to allow a gas to permeate into the reactor chamber and contain a nanoporous carbon,
   (v) a reactor head space disposed above the reactor cap, and
   (vi) at least one RA coil surrounding the reactor chamber and/or reactor head space operably connected to a power supply, wherein the computer processing unit is configured to control the power supply to the RA coil;
(d) powering each RA to a first electromagnetic energy level;
(e) subjecting the nanoporous carbon powder to harmonic patterning to instantiate product compositions; and
(f) collecting the chemical reactant from the product compositions.

The invention further includes chemical reactants produced by the foregoing processes.

The reactor assembly can further comprise a pole disposed below the reactor chamber and above the gas inlet, which pole can be composed of quartz. In embodiments, the nanoporous carbon comprises graphene having at least 95% wt. carbon (metals basis) having a mass mean diameter between 1 μm and 5 mm, and an ultramicropore surface area between about 100 and 3000 m²/g. In embodiments, the nanoporous carbon has been degassed. In embodiments, the cup is composed of graphite and the cap can be composed of graphite, platinum, palladium or ruthenium. In embodiments, the at least one RA coil is an induction coil. In embodiments, the product gas comprises at least about 1% vol. of the chemical reactant.

In another aspect, the invention includes methods of producing calcium oxide comprising:
(a) providing a set of one or more RAs, wherein the set of one or more RAs is configured to instantiate elemental calcium;
(b) instantiating elemental calcium in the set of one or more RAs; and
(c) directing the elemental calcium to react with oxygen, thereby producing the calcium oxide.

In embodiments, the oxygen is sourced from a feedgas line; in embodiments, the oxygen is produced from an auxiliary set of one or more RAs configured to produce oxygen; in embodiments, the oxygen is obtained from ambient atmosphere. In embodiments, the method further comprises a step of storing the calcium oxide in a protective environment, wherein the protective environment is an airtight container or an inert atmosphere, which can comprise, without limitation, one or more noble gases or which comprises nitrogen.

The invention also includes methods of producing calcium oxide and/or calcium hydroxide, comprising:
(a) providing a set of one or more RAs, wherein the set of one or more RAs is configured to instantiate elemental calcium;
(b) instantiating elemental calcium in the set of one or more RAs;
(c) directing the elemental calcium to react with oxygen, thereby producing the calcium oxide; and
(d) hydrating the calcium oxide by exposing it to H₂O, thereby producing calcium hydroxide.

In embodiments, the O₂ is produced by a second set of RAs. In embodiments, the H₂O is generated by reacting hydrogen produced by a third set of one or more RAs with oxygen to form the H₂O, wherein the hydrogen is produced by a third set of RAs. In other embodiments, the H₂O is generated by reacting hydrogen produced by the third set of one or more RAs in combination with oxygen to form the H₂O. In embodiments, the oxygen for forming the H₂O is produced by a fourth set of RAs, and the oxygen for forming the calcium oxide is produced by the second set of RAs. In embodiments, molecular calcium hydroxide can be produced directly by RAs which are so configured.

The invention further includes systems for producing a chemical reaction, comprising at least one RA that instantiates a substance, wherein the substance is calcium; and a conduit in fluid communication with the at least one RA and to a RS, wherein the conduit delivers the substance from the at least one RA into the RS, and wherein the RS supports the chemical reaction that consumes at least a portion of the substance. In embodiments, the system further comprises an auxiliary RA that instantiates a reactant capable of reacting with the substance; and a second conduit in fluid communication with the auxiliary RA and the RS that delivers the reactant from the auxiliary RA into the RS, wherein the reactant within the RS interacts with the substance to produce the chemical reaction. In an embodiment, the chemical reaction yields an oxidized form of the substance. The system can further comprise: (a) an auxiliary RA that instantiates a reactant capable of reacting with the substance; and (b) a second conduit in fluid communication with the auxiliary RA and the RS that delivers the reactant from the auxiliary RA into the RS, wherein the reactant within the RS interacts with the substance to produce the chemical reaction. In an embodiment, the reactant comprises oxygen, or consists essentially of oxygen.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of an E/MEE of the invention.

FIGS. 2A and 2C show reactor assembly components. FIG. 2B is an expanded view of the reactor assembly components of FIG. 2A.

FIG. 3A, FIG. 3B, FIG. 3C, FIG. 3D and FIG. 3E provides five views of coils which can be used in a reactor assembly.

FIG. 4A is a perspective view of an E/MEE of the invention used in carbon pretreatment.

FIG. 4B shows reactor assembly components.

FIG. 5A illustrates one conformation for a standard coil. FIG. 5B illustrates one conformation for a reverse field coil.

FIGS. 6A and 6B are illustrations of two examples of two composite reactor assemblies. FIG. 6A illustrates a Composite Reactor with a copper body, carbon graphite cup and a carbon graphite cap and a metal foil boundary. FIG. 6B illustrates a Composite Reactor with a carbon graphite body and cap and metal foil boundary.

FIG. 7 illustrates the nucleation of elemental nanostructures. The photograph clearly shows graphite like and graphene sheets and rods protruding from within a graphene pore. The rods are silicon calcium in this photo. To the right of the photograph, titanium nanospheres in light grey can be identified.

FIGS. 8A-8I illustrate various reactor assembly views according to the invention.

FIGS. 9A-9C are illustrations of reactor variations.

FIG. 10 is a diagram of an exemplary system comprising a reactor assembly.

FIG. 11 is a more detailed block diagram of the system illustrated in FIG. 10.

FIGS. 12A and 12B are schematic diagrams illustrating systems for producing CaO and Ca(OH)₂ (respectively) according to the invention.

FIG. 13A, FIG. 13B, FIG. 13C, FIG. 13D and FIG. 13E are periodic tables illustrating elements detected in the carbon matrices produced by the processes of the invention.

### DETAILED DESCRIPTION

The invention relates to methods of instantiating chemical reactants or materials, such as metals, in nanoporous carbon powders. As used herein, the term “feedstock” refers to a chemical substance (i.e., a chemical reactant) that is converted into other useful chemical substances (i.e., products) in a chemical reaction. While chemical reactants produced by the methods and apparatuses disclosed herein can be formed as fluids (preferably gases), solids, or other states of matter, in preferred embodiments, the chemical reactant produced is an elemental metal such as calcium, which can subsequently be used for chemical reactions such as redox reactions with oxygen to produce other chemical substances such as calcium oxide and calcium hydroxide. In other preferred embodiments, a second chemical reactant such as oxygen can be produced using the apparatus and methods of the invention, so that this second chemical reactant can react with the first chemical reactant, such as an elemental metal such as calcium to form products such as calcium oxide and calcium hydroxide.

The invention involves the production of a chemical reactant (a feedstock substance) using methods comprising the steps of contacting a bed comprising a nanoporous carbon powder with a feedgas composition, and optionally an electromagnetically activated gas, while applying electromagnetic radiation to the nanoporous carbon powder for a time sufficient to cause instantiation within and/or from carbon nanopores of the feedstock substance such as elemental metal nanoparticles. The process results in a product composition comprising a chemical reactant substantially distinct from the feedgas composition. In embodiments, the process results in a composition comprising a nanoporous carbon powder characterized by (i) elemental metal nanoparticles deposited within carbon nanopores and/or (ii) agglomerated, or aggregated, elemental metal nanoparticles, creating macrostructures such as elemental metal nuggets, nanonuggets, nanowires and other macrostructures that can be easily separated from the nanoporous carbon powder. The processes of the invention have broad applicability in producing chemical reactants, including elemental metal macrostructures, that can be collected from these apparatuses for further use in conventional reactions, or that can be combined with other chemical reactants produced by the methods disclosed herein to form useful products to be collected and commercialized as formed.

The invention further relates to the nanoporous carbon compositions, elemental metal nanoparticles and elemental metal macrostructures produced by the methods of the invention. The use of the terms agglomeration and aggregation is not intended to infer a specific order of assembly of the macrostructures. That is, it is not assumed that discrete nanoparticles are formed and then relocate and assemble to form an aggregate, as may be considered common in powder handling with electrostatically assembled products. Rather, without being bound by theory, it is believed that the agglomeration or aggregation occurs as nanoparticles are formed in ultramicropores. The invention contemplates compositions comprising a nanoporous carbon powder comprising (a) nanopores having disposed therein elemental metal nanostructures and (b) an elemental metal macrostructure wherein the elemental metal macrostructure further comprises internal carbon.

The invention relates to the discovery that carbon matrices can be used to instantiate, or filter, or isolate, or extract, or nucleate, a variety of substances, for example producing nano-deposits, nanostructures, nanowires and nuggets comprising metals or non-metals, by employing processes that include the application of electromagnetic radiation, directly and/or indirectly, to gases, nano-porous carbon, or compositions and combinations thereof, thereby pre-treating these materials, and thereafter exposing a carbon matrix to pre-treated gas in an apparatus to cause metal or non-metal instantiation, nucleation, growth and/or deposition within the carbon matrix.

In more detail, the invention relates to methods of instantiating chemical substances in any form, whether fluids (preferably gases), solid, or other. In embodiments, the invention produces metals and non-metals in nanoporous carbon matrices, through processes comprising the steps of contacting a bed comprising nanoporous carbon with an activated gas while applying electromagnetic radiation to the nanoporous carbon for a time sufficient to cause instantiation, including but not limited to nucleation, growth deposition and/or agglomeration, of elemental metal or non-metal nanoparticles within and/or from carbon nanopores and nano-pore networks and matrices. Such processes result in nanoporous carbon compositions or matrices characterized by elemental metals and/or non-metals deposited within carbon nanopores and agglomerated elemental nanoparticles, creating elemental metal nuggets, nanowires and other macrostructures that can be easily separated from the nanoporous carbon. In embodiments, these processes can produce elemental metal composition and macrostructures; in embodiments, the nanoporous carbon composition can also comprise non-metal nanostructures and/or macrostructures. In embodiments, the processes can instantiate, or filter, or isolate, or extract, or nucleate, materials containing carbon, oxygen, nitrogen, sulfur, phosphorous, selenium, hydrogen, and/or halides (e.g., F, Cl, Br and I). Nanoporous carbon compositions further comprising metal oxides, nitrides, and sulfides such as copper oxide, molybdenum sulfide, aluminum nitride have been identified. Therefore, small inorganic molecules or compounds (e.g., molecules comprising 2, 3, 4, 5, 6, 7, 8, 9 or 10 or 25 atoms) can be instantiated, or filtered, or isolated, or extracted, or nucleated, using the processes disclosed herein. Examples of such small molecules include carbides, oxides, nitrides, sulfides, phosphides, halides, carbonyls, hydroxides, hydrates including water, clathrates, clathrate hydrates, and metal organic frameworks.

### 1. Nanoporous Carbon Powders and Compositions

a. Nanoporous Carbon Powders

Nanoporous carbon powders or nanostructued porous carbons can be used in the processes and methods of the invention. Nanoporous carbon powders or nanostructued porous carbons are also referred to herein as “starting material” or “charge material”. The carbon powder preferably provides a surface and porosity (e.g., ultra-microporosity) that enhances metal deposition, including deposit, instantiation and growth. Preferred carbon powders include activated carbon, engineered carbon, graphite, and graphene. For example, carbon materials that can be used herein include graphene foams, fibers, nanorods, nanotubes, fullerenes, flakes, carbon black, acetylene black, mesophase carbon particles, microbeads and, grains. The term “powder” is intended to define discrete fine, particles or grains. The powder can be dry and flowable or it can be humidified and caked, such as a cake that can be broken apart with agitation. Although powders are preferred, the invention contemplates substituting larger carbon materials, such as bricks and rods including larger porous carbon blocks and materials, for powders in the processes of the invention.

Certain of the examples used herein describe highly purified forms of carbon, such as >99.995% wt. pure carbon (metals basis). Highly purified forms of carbon are exemplified for proof of principle, quality control and to ensure that the results described herein are not the result of cross-contamination or diffusion within the carbon source. However, it is contemplated that carbon materials of less purity can also be used. Thus, the carbon powder can comprise at least about 95% wt. carbon, such as at least about 96%, 97%, 98% or 99% wt. carbon. In a preferred embodiment, the carbon powder can be at least 99.9%, 99.99% or 99.999% wt. carbon. In each instance, purity can be determined on either an ash basis or on a metal basis. In another preferred embodiment, the carbon powder is a blend of different carbon types and forms. In one embodiment, the carbon bed is comprised of a blend of different nano-engineered porous carbon forms. Carbon powders can comprise dopants. Dopants can be measured in the carbon powder starting materials by the same techniques as can measure the elemental metal nanostructures as described below. Applicants believe that metal, semi-metal and non-metal dopants can impact the formation of elemental metal nanostructures.

The carbon powder preferably comprises microparticles. The volume median geometric particle size of preferred carbon powders can be between less than about 1 μm and 5 mm or more. Preferred carbon powders can be between about 1 μm and 500 μm, such as between about 5 μm and 200 μm. Preferred carbon powders used in the exemplification had median diameters between about 7 μm and 13 μm and about 30 μm and 150 μm.

The dispersity of the carbon particle size can improve the quality of the products. It is convenient to use a carbon material that is homogeneous in size or monodisperse. Thus, a preferred carbon is characterized by a polydispersity index of between about 0.5 and 1.5, such as between about 0.6 and 1.4, about 0.7 and 1.3, about 0.8 and 1.2, or between about 0.9 and 1.1. The polydispersity index (or PDI) is the ratio of the mass mean diameter and number average diameter of a particle population. Carbon materials characterized by a bimodal particle size can offer improved gas flow in the reactor.

The carbon powder is preferably porous. The pores, or cavities, residing within the carbon particles can be macropores, micropores, nanopores and/or ultra-micropores. A pore can include defects in electron distribution, compared to graphene, often caused by changes in morphology due to holes, fissures or crevices, corners, edges, swelling, or changes in surface chemistry, such as the addition of chemical moieties or surface groups, etc. For example, variation in the spaces that may arise between layers of carbon sheets, fullerenes or nanotubes are contemplated. It is believed that instantiation preferentially occurs at or within a pore or defect-containing pore and the nature of the surface characteristics can impact instantiation. For example, Micromeritics enhanced pore distribution analysis (e.g., ISO 15901-3) can be used to characterize the carbon. It is preferred that the carbon powder is nanoporous. A “nanoporous carbon powder” is defined herein as a carbon powder characterized by nanopores having a pore dimension (e.g., width or diameter) of less than 100 nm. For example, IUPAC subdivides nanoporous materials as microporous (having pore diameters between 0.2 and 2 nm), mesoporous materials (having pore diameters between 2 and 50 nm) and macroporous materials (having pore diameters greater than 50 nm). Ultramicropores are defined herein as having pore diameters of less than about 1 nm.

Uniformity in pore size and/or geometry is also desirable. For example, ultramicropores in preferred carbon materials (e.g., powders) account for at least about 10% of the total porosity, such as at least about 20%, at least about 30%, at least about 40%, at least about 50%, at least about 60%, at least about 70%, at least about 80%, or at least about 90%. Preferred carbon materials (e.g., powders) are characterized with a significant number, prevalence or concentration of ultra-micropores having the same diameter, thereby providing predictable electromagnetic harmonic resonances and/or standing wave forms within the pores, cavities, and gaps. The word “diameter” in this context is not intended to require a spherical geometry of a pore but is intended to embrace a dimension(s) or other characteristic distances between surfaces. Accordingly, preferred carbon materials (e.g., powders) are characterized by a porosity (e.g., nanopores or ultramicropores) of the same diameter account for at least about 10% of the total porosity, such as at least about 20%, at least about 30%, at least about 40%, at least about 50%, at least about 60%, at least about 70%, at least about 80%, or at least about 90%.

Measuring adsorption isotherm of a material can be useful to characterize the surface area, porosity, e.g., external porosity, of the carbon material. Carbon powders having a surface area between about 1 m²/g and 3000 m²/g are particularly preferred. Carbon powders having an ultramicropore surface area of at least about 50 m²/g, preferably at least about 300 m²/g, at least about 400 m²/g, at least about 500 m²/g or higher are particularly preferred. Activated or engineered carbons, and other quality carbon sources, can be obtained with a surface area specification. Surface area can be independently measured by BET surface adsorption technique.

Surface area correlation with metal deposition was explored in a number of experiments. Classical pore surface area measurements, using Micromeritics BET surface area analytical technique with nitrogen gas at 77K (−196.15° C.) did not reveal a substantial correlation in the deposition of metal elements at ≥5σ confidence level, or probability of coincidence. However, a correlation with ultramicropores (pores having a dimension or diameter of less than 1 nm) was observed. Without being bound by theory, instantiation is believed to be correlated to resonating cavity features of the ultra-micropore and ultramicropore network such as the distance between surfaces or walls. Features of the ultramicropore, can be predicted from ultramicropore diameter as measured by BET, augmented by density function theory (DFT) models, for example. With the aid of machine learning, more precise relationships between ultramicropore size, distribution, turbostratic features, wall separation and diameter and elemental metal nucleation can be established.

Carbon materials and powders can be obtained from numerous commercial providers. MSP-20X and MSC-30 are high surface area alkali activated carbon materials with nominal surface areas of 2,000-2,500 m²/g and >3,000 m²/g and median diameters of 7-13 μm and 60-150 μm respectively (Kansai Coke & Chemicals Co). Norit GSX is a steam-washed activated carbon obtained from Alfa Aesar. The purified carbon forms used in the experimental section all exceed ≥99.998 wt % C (metals basis).

Modifying the surface chemistry of the carbon can also be desirable. For example, improved performance was observed when conditioning the carbon with an acid or base. Contacting the carbon with a dilute acid solution selected from the group consisting of HCl, HF, HBr, HI, sulfuric acid, phosphoric acid, carbonic acid, and nitric acid followed by washing with water (such as deionized water) can be beneficial. The acid is preferably in an amount less than about 30%, less than about 25%, less than about 20% less than about 15%, less than about 10%, or less than about 5%, preferably less than or equal to 1% vol. The preferred acid for an acid wash is an acid having a pKa of less than about 3, such as less than about 2. After washing, it can be beneficial to subject the carbon to a blanket of a gas, such as helium, hydrogen or mixtures thereof. Alternative gases can include, without limitation, carbon monoxide, carbon dioxide, nitrogen, argon, neon, krypton, helium, ammonia and hydrogen. The carbon can also be exposed to a base, such as KOH before or after an acid treatment.

Controlling residual water content in the carbon which may include moisture can improve performance. For example, the carbon material can be placed in an oven at a temperature of at least about 100° C., preferably at least about 125° C., such as between 125° C. and 300° C. for at least 30 minutes such as about an hour. The oven can be at ambient or negative pressure, such as under a vacuum. Alternatively, the carbon material can be placed in an oven with high vacuum at a temperature of at least about 250° C., preferably at least about 350° C., for at least one hour, such as at least 2, 3, 4, 5, or 6 hours. Alternatively, the carbon material can be placed in an oven with high vacuum at a temperature of at least about 700° C., preferably at least about 850° C., for at least one hour, such as at least 2, 3, 4, 5, or 6 hours. Alternatively, the water or moisture can be removed by vacuum or lyophilization without the application of substantial heat. Preferably, the water, or moisture, level of the carbon is less than about 35%, 30%, 25%, 20%, 15%, 10%, 5%, such as less than about 2%, by weight carbon. In other embodiments, the carbon can be exposed to a specific relative humidity (RH) such as 0.5%, 1%, 2%, 5%, 12% RH or 40% RH or 70% RH or 80% RH or 90% RH, for example, at 22° C.

Pre-treatment of the carbon material can be selected from one or more, including all, the steps of purification, humidification, activation, acidification, washing, hydrogenation, drying, chemistry modification (organic and inorganic), and blending. For example, the carbon material can be reduced, protonated or oxidized. The order of the steps can be as described, or two or more steps can be conducted in a different order.

For example, MSP-20X was exposed to an alkali (C:KOH at a molar ratio of 1:0.8), activated at 700° C. for 2 hours, washed with acid and then hydrogenated to form MSP-20X Lots 1000 when washed with HCl and 105 when washed with HNO3. MSP-20X was washed with acid and then hydrogenated to form MSP-20X Lots 1012 when washed with HCl and 1013 when washed with HNO3. Activated carbon powder developed for the storage of hydrogen was HCl acid washed, then subjected to HNO3 washing and hydrogenation to form APKI lots 1001 and 1002, as substantially described in Yuan, J. Phys. Chem. B20081124614345-14357. Poly(ether ether ketone) (PEEK, Victrex 450P) and poly(ether imide) (PEI, Ultem® 1000) was supplied by thermally oxidized in static air at 320° C. for 15 h and carbonized at the temperature range of 550-1100° C. in nitrogen atmosphere, at the carbon yield of 50-60 wt %. These carbons were then activated by the following procedures: (1) grind the carbonized polymer with KOH at KOH/carbon ˜1/1-1/6 (w/w), in the presence of alcohol, to form a fine paste; (2) heat the paste to 600-850° C. in nitrogen atmosphere for 2 h; (3) wash and rinse with DI water and dry in vacuum oven. PEEK/PEI (50/50 wt) blend was kindly supplied by PoroGen, Inc. Likewise, the acid washing sequence of Lots 1001 and 1002 was reversed to form APKI lots 1003 and 1004. Universal grade, natural graphite, ˜200 mesh was purchased from Alfa Aesar, product number 40799. Graphite lots R and Z were HCl washed and hydrogenated to form R lot 1006 and Z lot 1008, respectively. Alfa Aesar graphite R and Z were nitric acid washed and hydrogenated to form R lot 1007 and Z lot 1009, respectively. MSC-30 (Kansai Coke and Chemicals) was acid washed and then hydrogenated to form MSC30 lots 1010 when washed with HCl and 1011 when washed with HNO3. MSC-30 was exposed to an alkali (C:KOH at a molar ratio of 1:0.8), activated at 700C for 2 hours, HCl or nitric acid washed and then hydrogenated to form MSC-30 lots 1014 (HCl washed) and 1015 (HNO3 washed), respectively. MSP-20X, MSC-30, Norit GSX and Alfa Aesar R were subjected to purification by MWI, Inc. for MSP-20X Lots 2000 and 2004, MSC-30 Lots 2001, 2006 and 2008, Norit GSX Lots 2005 and 2007, and Alfa Aesar R Lot 2009 respectively. MSP-20X Lot 2000 and MSC-30 2001 were HCl washed and hydrogenated to form MSP-20X Lot 2002 and MSC-30 Lot 2003, respectively. Alfa Aesar R was washed with 1%, 5%, 10%, 15%, 20%, 25%, and 30% HCl (vol.) and then hydrogenated to for R Lot Graphite n % vol HCl, respectively. Purified MSP-20X (Lot 2006) was similarly washed by HCl, nitric acid, HF or H₂SO₄ to form MSP-20X 1% HCl, MSP-20X 1% HNO3, MSP-20X 0.4% HF, MSP-20X 0.55% H₂SO₄ (Lot 1044), respectively. Purified Norit GSX (Lot 2007) was similarly washed by nitric acid, HF or H₂SO₄ to form Norit GSX 1% HNO3 (Lot 1045), Norit-GSX 0.4% HF, Norit-GSX 0.55% H₂SO₄, respectively. Purified MSC30 (Lot 2008) was similarly washed by HCl and H₂SO₄ to form MSC30 1% HCl, and MSC30 5% H₂SO₄. Purified MSP20X (Lot 2006), Norit GSX (Lot 2007) and MSC30 (Lot 2008) were hydrogenated. Purified MSP-20X, Norit GSX and MSC30 were washed with 1% HCl using methanol as a wetting agent. APKI-S-108 Lots 1021-1024 were recycled. The Ref-X Blend is a 40% Alfa Aesar R: 60% MSP-20X (lot 2006) 850° C. desorb then CO₂ exposure at 138 kPa (20 psi) for 5 days.

It is preferred to degas the nanoporous carbon powder prior to initiating the process. For example, the nanoporous carbon powder can be degassed by subjecting the powder to a vacuum. A range of vacuums can be used, with or without elevated temperatures. It has been found that applying a vacuum of about 10⁻² torr to 10⁻⁶ torr was sufficient. The powder can be degassed prior to charging the powder into the reactor chamber. Preferably the powder can be degassed after the powder is charged into the reactor chamber. In the examples below, which are non-limiting, the carbon powder is charged into the reactor chamber, placed into the reactor assembly and the entire reactor assembly is subjected to a degassing step by maintaining the reactor assembly under vacuum. The degassing step can be performed at ambient temperature or an elevated temperature. For example, good results were achieved at a temperature of 400° C. Other temperatures can be at least 50° C., such as at least 100° C., at least 150° C., at least 200° C., or at least 300° C. The degassing step can be maintained for at least 30 minutes, such as at least 45 minutes, at least 60 minutes, at least 4 hours, at least 6 hours, at least 12 hours, or at least 24 hours. Degassing the carbon powder ensures that contaminant elements have been removed from the system.

The carbon can be recycled or reused. In recycling the carbon, the carbon can optionally be subjected to an acid wash and/or water removal one or more times. In this embodiment, the carbon can be reused one or more times, such as 2, 3, 4, 5, 10, 15, 20, or about 25 or more times. The carbon can also be replenished in whole or in part. It has been discovered that recycling or reusing the carbon can enhance metal nanostructure yields and adjust nucleation characteristics enabling change in element selectivity and resultant distributions. Thus, an aspect of the invention is to practice the method with recycled nanoporous carbon powder, e.g., a nanoporous carbon powder that has been previously subjected to a method of the invention one or more times.

b. Nanoporous Carbon Compositions and Metal Deposits

The nanoporous carbon compositions produced by the processes described herein possess several surprising and unique qualities. The nanoporosity of the carbon powder is generally retained during processing and can be confirmed, for example, visually with a scanning electron microscope or modeled by BET analysis. Visual inspection of the powder can identify the presence of elemental nanostructures residing within and surrounding the nanopores. The nanostructures can be elemental metals or non-metals. Visual inspection of the powder can also identify the presence of elemental macrostructures residing within and surrounding the nanopores. The metal nanostructures and/or metal macrostructures (collectively, “metal deposits”) produced by the process can be isolated or harvested from nanoporous carbon compositions. The metal deposits of the invention also possess several surprising and unique qualities. The macrostructures can be elemental metals or nonmetals, and can contain interstitial and/or internal carbon, as generally described by Inventor Nagel in U.S. Pat. Nos. 10,889,892 and 10,844,483, each of which is incorporated herein by reference in its entirety. Methods for instantiating metals are described in U.S. Ser. No. 17/122,355 by Inventor Nagel, which is incorporated herein by reference in its entirety. Methods for instantiating gases are described in U.S. Ser. No. 63/241,697 by Inventor Nagel, which is incorporated herein by reference in its entirety.

Typically, the porosity of the nanoporous carbon compositions will be at least about 70% of the porosity attributed to ultramicropores of the nanoporous carbon powder starting, or charge, material and having a total void volume that is about 40% or more of the bulk material volume. The pores, or cavities, residing within the carbon particles can be macropores, micropores, nanopores and/or ultra-micropores. A pore can include defects in electron distribution, compared to graphene, often caused by changes in morphology due to holes, fissures or crevices, edges, corners, swelling, dative bonds, or other changes in surface chemistry, such as the addition of chemical moieties or surface groups, etc. For example, the spaces that may arise between layers of carbon sheets, fullerenes, nanotubes, or intercalated carbon are contemplated. It is believed that deposit and instantiation preferentially occurs at or within a pore and the nature of the surface characteristics can impact the deposit. For example, Micromeritics enhanced pore distribution analysis (e.g., ISO 15901-3) can be used to characterize the carbon. It is preferred that the carbon powder is nanoporous. Chemical reactant products or product compositions that are produced by the process can be isolated or harvested from nanoporous carbon compositions.

The products can also be characterized by uniformity in pore size and/or geometry. For example, ultramicropores can account for at least about 10% of the total porosity, such as at least about 20%, at least about 30%, at least about 40%, at least about 50%, at least about 60%, at least about 70%, at least about 80%, or at least about 90%. Carbon materials (e.g., particles or powders) can be characterized with a significant number, prevalence or concentration of ultra-micropores having the same dimension (e.g., width or diameter) or the same distribution of pore dimensions or dimensions characterizing the pore network, thereby providing predictable electromagnetic harmonic resonances within the pores. Accordingly, carbon materials (e.g., powders) can be characterized by a porosity (e.g., nanopores or ultramicropores)) of the same diameter or diameter distribution account for at least about 10% of the total porosity, such as at least about 20%, at least about 30%, at least about 40%, at least about 50%, at least about 60%, at least about 70%, at least about 80%, or at least about 90%.

Measuring surface area of a material can be useful to characterize the porosity, e.g., external porosity, of the carbon material. The carbon powder preferably is characterized by a high surface area. For example, the nanoporous carbon powder can have a general surface area of at least about 1 m²/g or at least about 200 m²/g, at least about 500 m²/g or at least about 1000 m²/g. The ultra-micropore surface area can be at least about 50 m²/g, such between 100 m²/g and 3,000 m²/g. The ultramicropore surface area of at least about 50 m²/g, preferably at least about 300 m²/g, at least about 400 m²/g, at least about 500 m²/g or higher are particularly preferred. Activated carbons, and other quality carbon sources, can be obtained with a surface area specification. Surface area can be independently measured by BET surface adsorption technique.

Carbon materials (e.g., powders and particles) include activated carbon, engineered carbon, natural and manufactured graphite, and graphene. For example, carbon materials that can be used herein include, without limitation, microparticles, graphene foams, fibers, nanorods, nanotubes, fullerenes, flakes, carbon black, acetylene black, mesophase carbon particles, microbeads and, grains. Typically, a powder can be sufficiently dry to be flowable without substantial aggregation or clumping or it can be humidified and caked, such as a cake that can be broken apart with agitation. Although powders are preferred, the invention contemplates substituting larger carbon materials, such as bricks and rods, for powders in the processes of the invention.

Typically, the sp²-sp³ character of the carbon composition (e.g., the internal carbon) changed as carbon rich to metal rich structures was traversed, as determined by TEM-EELs (transition electron microscopy-electron energy loss spectroscopy).

The nanoporous carbon compositions are typically characterized by the presence of “detected metals,” or a “reduced purity,” as compared to the nanoporous carbon powder starting material, as determined by X-ray fluorescence spectrometry (XRF) using standardized detection methods. ED-XRF and WD-XRF can be used. In addition, Energy Dispersive Spectroscopy (EDS or EDX or HR-Glow Discharge Mass Spectrometry (GD-MS) as well as Neutron Activation Analysis (NAA), Parr Bomb Acid Digestion with ICP-MS, PIXE and GD-OES can be used in addition, in the alternative or in any combination. For example, in the experimentation described below, carbon materials with a purity of at least 99.9% by weight was used as an initial starting material and most typically at least 99.99% by weight on a metals basis. Such carbon materials can comprise small (e.g., <1% by weight) metals, or dopants. Such pre-existing metals, including dopants, are not included within the “detected metals” definition. Products of the invention were characterized by deposited elemental metal nanostructures and nano-deposits that were detected by XRF, EDS/EBSD and other methods. The resulting carbon powder products characterized by such metal deposits can be characterized as having a “reduced purity.” The term, “detected metals,” is defined herein to exclude any element or material introduced by the carbon starting material, gas supply, gas line, or reactor assembly, including the reactor frits, cup and/or cap (collectively “reactor components”). By way of an example, where the reactor is selected from a copper cup which contains the carbon material, and the process results in a mass reduction of 1 μg of copper from the cup, then a “detected metal” excludes 1 μg copper. In addition, the elemental composition(s) of the reactor components and reactor feed gas can be compared to the detected metals. Where the reactor components differ in elemental composition, the detection of one or more metals not present in any of the reactor components supports the conclusion that the detected metal is not derived from the reactor components. For example, where the detected metal contains 5 ppm wt Mo or 4 ppm wt W in addition to copper within an elemental metal macrostructure, and the reactor cup is 99.999% copper with no detectable Mo or W, the copper identified within the detected metal can also be attributed to the total detected metals. Typically, at least about 1% of the total non-carbon elements contained within the carbon composition are detected metals or components, on a mass basis. Preferably, detected metals are at least about 2%, 3%, 4%, 5%, 6%, 7%, 8%, 9%, 10%, 20%, 30%, 40%, 50%, 60% or 70% or more of the total non-carbon elements contained within the carbon composition on a mass basis.

In a preferred embodiment, the nanoporous carbon composition comprises at least 0.1 ppm detected metal, preferably between about 0.1 ppm-100 ppm, such as between about 50 ppm-5000 ppm, or between about 0.1% wt-20% wt, such as at least about >0.1% wt detected metals. Preferably the detected metals are at least 1 ppm of the nanoporous carbon composition. The detected metals can be or include the elemental metal nanostructures (or, simply metal nanostructures). The detected metals exclude metal ions or salts.

Carbon compositions subjected to the methods of the invention result in an altered carbon isotopic ratio. Thus, the invention includes methods of altering the carbon isotopic ratio comprising eh steps described below and compositions wherein the carbon isotopic ration has shifted.

The nanoporous carbon composition preferably comprises elemental metal nanostructures. The metal nanostructures preferably comprise one or more metals selected from the group consisting of transition metals (Group IIIB: Sc, Y, Lu; Group IVB: Ti, Zr, Hf; Group VB: V, Nb, Ta; Group VIB: Cr, Mo, W; Group VIIB: Mn, Re Group VIIIB: Fe, Ru, Os, Co, Rh, Ir, Ni, Pd, Pt; Group IB: Cu, Ag; Group IIB: Zn, Cd, Hg), alkaline earth metals (Group Ia: Li, Na, K, Rb, Cs), alkali metals (Group IIA: Be, Mg, Ca, Sr, Ba), lanthanides (La, Ce, Pr, Nd, Sm, Eu, Gd, Tb, Dy, Ho, Er, Tm and Yb), and light metals (B, Al, Si, S, P, Ga, Ge, As, Se, Sb, Te, In, TI, Sn, Pb, Bi). Platinum group metals and rare earth elements are preferred. Precious metals and noble metals can also be made. Other nanostructures comprising Li, B, Si, P, Ge, As, Sb, and Te can also be produced. Typically, the elemental metal nanostructures exclude metal ions.

The nanoporous carbon composition can also comprise non-metal nanostructures and/or macrostructures. For example, the processes of the invention can instantiate, or filter, or isolate, or extract, or nucleate, gases, such as hydrogen, oxygen, helium, neon, argon, krypton and xenon. Additionally or alternatively, the invention can instantiate, or filter, or isolate, or extract, or nucleate, materials containing carbon, oxygen, nitrogen, sulfur, phosphorous, selenium, hydrogen, and/or halides (e.g., F, Cl, Br and I). Additionally or alternatively, the invention can instantiate, or filter, or isolate, or extract, or nucleate, nanoporous carbon compositions further comprising metal oxides, nitrides, hydrides, and sulfides (e.g., copper oxide, molybdenum sulfide, aluminum nitride). In embodiments, small inorganic molecules or compounds (e.g., molecules comprising several metal atoms, e.g., 2, 3, 4, 5, 6, 7, 8, 9 or 10 atoms, or more) can be instantiated, or filtered, or isolated, or extracted, or nucleated, using the processes of the invention.

Examples of such small molecules include carbides, oxides, nitrides, sulfides, phosphides, halides, carbonyls, hydroxides, hydrates including water, clathrates, clathrate hydrates, and metal organic frameworks. Thus, the invention relates to metal macrostructures characterized by 3, 4, 5, 6, 7, 8, 9, 10 or more elemental metals. Preferred metal macrostructures comprise a preponderance of an elemental metal. A metal is “preponderant” within a macrostructure where the elemental weight content is substantially greater than one, two or more, or all of the other detected metals. For example, at least about 50%, 60%, 70%, 80%, 90% or more of the macrostructure comprises a preponderant elemental metal, e.g., calcium.

In embodiments, macrostructures with a preponderance of copper, nickel, iron, and/or molybdenum, can be prepared. Preferred macrostructures can comprise a preponderance of a single element such as >95% calcium, >95% copper, >95% Ni, >90% Mo, >90% Pt, and the like, or can comprise a preponderance of two, three, or more elemental metals, e.g., calcium. It is an aspect of the invention to characterize the elemental composition of a metal macrostructure normalized against the most preponderant metal.

The processes of the invention result in a nanoporous carbon composition comprising an ordered metal nano-deposit array wherein the metal nano-deposits are characterized by a diameter of less than 1 nm, preferably between about 0.1 and 0.3 nm, and the space between the metal deposit rows is less than about 1 nm, preferably between about 0.1 and 0.3 nm. The nanoporous carbon composition comprising the ordered array is preferably characterized by a carbon rich area and/or a metal (e.g., copper) rich adjacent to the array. For example, the array can be located between a carbon-metal (e.g., copper) interface. The array can be identified and characterized by tunneling electron microscopy (TEM). Typically, the TEM, and other microscopy devices, are used in accordance with the manufacturer's instructions. The metal nano-deposit array is presented (or located) on a carbon substrate wherein the carbon substrate preferably comprises sp² carbon. The term “nano-deposits” is intended to embrace nanostructures of less than about 1 nm and includes discrete atoms.

The processes of the invention result in a nanoporous carbon composition comprising a carbon-metal (e.g., copper or calcium) gradient wherein metal (e.g., copper or calcium) nanostructures are deposited on a carbon substrate in gradient at a carbon-metal interface. The carbon substrate preferably comprises sp² carbon. The gradient is preferably about 100 nm, or about 50 nm or less in width, such as less than about 10 nm in width. The gradient is defined by an increasing concentration of metal from a substantially pure carbon region to a substantially carbon-free region. The metal region can be characterized by an elemental composition consistent with the metal nano-deposits described herein.

In embodiments, the nanostructures can be spherical, as determined by visual inspection and SEM. The diameters of the nanostructures can be less than 5 microns, such as between 50 and 800 nm, such as between 100 and 200 nm. In embodiments, the nanostructures can have a flake, scale or chip morphology. In embodiments, the nanostructures can be characterized by a highly smooth surface (or a surface substantially free of rugosity). Rugosity is a measure of small-scale variations of amplitude in the height of a surface and can be characterized by the ratio of the true surface area divided by the geometric surface area. For example, a perfect sphere would have a rugosity of 1. Thus, nanostructures of the invention where the rugosity of each structure, as visually observed by STEM or TEM, is less than about 2, preferably less than about 1.5 such as less than about 1.2.

In addition, nanostructures of the invention can be characterized by an unusually high roundness. Roundness is used herein to define the ratio of the averaged radius of curvature of the convex regions to a circumscribed circle of the particle (or a surface defined by at least 40% of the visible perimeter of the particle, in the case of an ellipsoid), as visually observed by STEM, SEM or TEM, as calculated by the following Equation (EQ3)

$$Roundness = \frac{{\sum }_{i = 1}^{n} ( \frac{{r}_{i}}{R} )}{n} \qquad EQ3$$

Wherein R is the radius of a circumscribed circle, ri is the radius an inscribed circle at a convex corner i and n is the number of inscribed circles measured.

A roundness of 1 indicates the inscribed circle overlays the circumscribed circle. The invention includes nanostructures having a roundness of at least about 0.3, preferably at least about 0.4, 0.5, 0.6, 0.7, 0.8 or 0.9 as visually observed STEM, SEM or TEM.

The elemental metal nanostructures of the invention can further comprise internal voids and nanopores. In embodiments, the invention includes elemental metal porous nanostructures characterized by a numerical average diameter of less than about 10 μm, preferably less than about 1 micron and a numerical average pore diameter of less than about 1 μm, such as less than about 500 nm, less than about 200 nm or less than about 100 nm, as calculated visually from a TEM image of an elemental metal macrostructure.

The nanostructures further agglomerate or aggregate to form macrostructures within the carbon powder. Macrostructures are defined herein to include agglomerates or aggregates of nanostructures as well as structures visible to the naked human eye. The macrostructures can have a variety of morphologies, including a nanowire or thread having a width of less than about 1 micron. A nanowire is defined herein to include a linear agglomeration of nanostructures characterized by an aspect ratio of at least about 5, such as at least about 10, preferably at least about 25. Aspect ratio is the ratio of the length to the diameter of the nanowire as determined by visual inspection with an SEM. Macrostructures characterized by coiled nanostructures have also been observed. Large macrostructures have also been observed.

Without being bound by theory, it is believed that such micropores, whether located internally or on the surface of the macrostructure, can be used as further nucleation sites in the present method for additional instantiation. In embodiments, the invention includes elemental macrostructures characterized by at least one micropore protruding therefrom an elemental metal nanostructure wherein the nanostructure has a different metal composition than the macrostructure. As discussed above, macrostructures can be agglomerated nanostructures. The nanostructures can comprise the same or different elements. Typically, detection methods observe the nanostructures can be individually substantially pure.

The nanoporous carbon compositions described herein and made according to the present invention can be used as catalysts and electrodes. The elemental metal macrostructures described herein can be isolated from the nanoporous carbon compositions. For example, sieving the carbon powder with a porous sieve that will capture metal nanostructures of the desired size can be beneficial. The elemental metal macrostructures can be used, for example, in processes typical of mined metals.

c. Precious Metals and other Metal Deposits

Nanoporous carbon compositions and elemental metal macrostructures have been isolated that detect precious metals, such as gold and silver, and platinum group metals, such as platinum, palladium, osmium, rhodium, iridinium and ruthenium, and other metals, including elemental metals such as calcium. Thus, the invention includes elemental macrostructures and nanostructures that comprise precious metals, such as gold and silver, and platinum group metals, such as platinum, palladium, osmium, rhodium, iridinium and ruthenium, and other metals, including elemental metals such as calcium. The macrostructures comprising one or more of these elements can have internal carbon, such as amorphous or sp² carbon, as discussed in more detail above.

Such macrostructures were made using the GSA protocol, using a Z carbon starting material, a CuG reactor, and nitrogen gas and with the Electromagnetic Light Combing protocol, using a PEEK carbon starting material, a GG graphite reactor and CO gas, as disclosed herein.

The invention further includes carbon compositions comprising metal nanostructures, as can be made, for example, using the GSA protocol, helium gas, the GPtIr reactor, which lines the cup with a platinum foil and a variety of nanoporous carbon starting materials.

The target metal (e.g., precious metals, such as gold and silver, and platinum group metals, such as platinum, palladium, osmium, rhodium, iridinium and ruthenium, or other metals including elemental metals such as calcium) can be extracted from the carbon composition and other metals in the macrostructure by methods routinely used in the mining industry or other industries.

Compositions produced in accordance with the principles of the invention, with third party characterizations, are set forth in the following Table 1:

TABLE 1

| Sample | | | | | |
|---|---|---|---|---|---|
| Number | | Example 2 | Example 12 | Example 9 | Example 50 |
| Experimental | | GSA | E/LC | E/LC | QPP |
| Protocol | | | | | |
| Rx Assembly | | CuG | GG | G_{g}F | CuG |
| Gas | | N₂ | Co | Kr | He—H₂ |
| Composition | | | | | |
| Carbon Type | | Z-Lot | APK-800 | APKI-108 | MSP-20X |
| Temperature, | | 180° C. | 450° C. | 450° C. | 25° C. |
| Tₒₚₛ | | | | | |
| Elements | | | | | |
| (Instantiated) | | | | | |
| Category-1 | | 1 | 1 | 2 | 1 |
| | Elements | Cu | Cu | Fe, Cr | Fe |
| Category-2 | | 3 | 3 | 6 | 7 |
| | Elements | Na, Ca, Pt | SI, W, Re | Al, Ni, Zn, Hf, | Na, Ca, V, |
| | | | | Pb, Bi | Cr, Mn, Ni, |
| | | | | | Cu |
| Category-3 | | 5 | 14 | 8 | 5 |
| | Elements | Al, Si, K, Fe, | Na, Al, K, | Si, Ca, Mn, | Zn, Zr, Mo, |
| | | Ag | Ca, Ti, Cr, | Cu, Mo, Sn, | Sn, Sb |
| | | | Fe, Ni, Mo, | Sb, W | |
| | | | Sn, Ba, Ta, | | |
| | | | Os, Pb | | |
| Category-4 | | 46 | 46 | 33 | 18 |
| | Elements | Be, B, Mg, P, | Li, Be, B, | Li, B, Na, Mg, | Ti, Co |
| | | Sc, Ti, V, Cr, | Mg, P, Sc, V, | P, K, Sc, Ti, | |
| | | Mn, Co, Ni, | Mn, Co, Zn, | V, Co, Ga, Ge, | |
| | | Zn, Ga, Ge, | Ga, Ge, Se | Se | |
| | | As, Se, | | | |
| | | Rb, Sr, Y, Zr, | Rb, Sr, Y, Zr, | Rb, Sr, Y, Zr, | Nb |
| | | Nb, Mo, Ru, | Nb, Ru, Ag, | Nb, Ru, Pb, | |
| | | Cd, Sn, Sb, | Cd, Sb, Te | Ag, Cd, Te | |
| | | Te, | | | |
| | | Cs, Ba, La, | La, Ce, Pr, | Ba, Ce, Nd, | Ce, Pr, Nd, |
| | | Nd, Sm, Gd, | Nd, Sm, Eu, | Gd, Yb | Sm, Eu, Gd, |
| | | Eu | Gd, Tb, Dy, | | Tb, Dy, Ho, |
| | | | Ho, Er, Tm, | | Er, Tm. Yb, |
| | | | Yb, Lu | | Lu |
| | | Hf, W, Re, | Hf, Ir, Pt, Au, | Re, Os, Pt, Hg, | Hf, W |
| | | Os, Ir, Au, | Hg, Tl, Bi, | Tl | |
| | | Hg, Tl, Pb, | Th, U | | |
| | | Bi, Th, U | | | |
| | Instantiated | 55 | 64 | 49 | 31 |
| | Elements | | | | |
| Analysis | | | | | |
| Internal | | ED-XRF, | ED-XRF, | ED-XRF, | ED-XRF, |
| | | EBD-SEM, | EBD-SEM, | EBD-SEM, | EBD-SEM, |
| | | optical | optical | optical | optical |
| | | microscopy | microscopy | microscopy | microscopy |
| | | LA-ICP-MS, | LA-ICP-MS, | LA-ICP-MS, | LA-ICP-MS, |
| | | EBD-SEM, | EBD-SEM, | EBD-SEM, | EBD-SEM, |
| External | | optical | optical | optical | optical |
| | | | CAMECA | TEM, STEM, | |
| | | TEM, STEM, | SX5 Electron | SEM, Gamma | |
| | | SEM, EELS | Microprobe | Spectroscopy | |

### 2. METHODS AND APPARATUS

Conceptually, the apparatus for baseline experimentation can be broken into two primary areas: Gas Processing and Reactor Assembly.

a. Gas Processing:

The gas processing section controls gas composition and flow rate, with the optional embedding of electromagnetic (e.g., light) information or electromagnetic gas pre-treatment to the reactor. The invention includes an electromagnetic embedding enclosure (E/MEE or EMEE), or apparatus, for processing a gas (feed gas or first gas composition, used interchangeably herein) comprising or consisting of:
a central processing unit and power supply;
one or more gas supplies;
a housing having a housing inlet and housing outlet;
an upstream gas line that is in fluid connection with each gas supply and the housing inlet;
an internal gas line in fluid connection with the housing inlet and housing outlet;
a downstream gas line in fluid connection with the housing outlet;
at least one pencil lamp positioned below the internal gas line, at least one pencil lamp positioned above the internal gas line and/or at least one pencil lamp positioned to the side of the internal gas line;
an optional short-wave lamp and/or a long wave lamp; and
an optional coil wrapped around the internal gas line, operably connected to a frequency generator;
wherein each lamp is independently rotatably mounted, located along the length of the internal gas line, and powered by the power supply; and
wherein the central processing unit independently controls powering the frequency generator, if present, and each lamp and the rotation position of each lamp.

It will be understood that spatial terms, such as “above”, “below”, “floor” and “to the side” are relative to a particular specified object or other point of reference. Thus, a lamp, for example, that is positioned “above” a gas line takes its orientation from the gas line as reference point; if the gas line is positioned “above” the floor of the room in which the apparatus is housed, the lamp positioned “above” the gas line is also “above” the floor. A lamp that is positioned “above” the floor does not have a designated position with respect to a gas line that is also positioned “above” the floor unless the lamp's position is also specified with reference to said gas line. In other words, if one were to draw X, Y and Z axes through a particular assembly or apparatus, the terms “above”, “below” and “to the side” is intended to only refer to positions relative to such axes and not as the axes would be drawn relative to the space or room in which the assembly resides.

Feed gases can preferably be research grade or high purity gases, for example, as delivered via one or more gas supplies, such as a compressed gas cylinder. Examples of gases that can be used include, for example and without limitation, air, oxygen, nitrogen, helium, neon, argon, krypton, xenon, ammonium, carbon monoxide, carbon dioxide and mixtures thereof. Preferred gases include nitrogen, helium, argon, carbon monoxide, carbon dioxide and mixtures thereof. Nitrogen, air and helium are preferred. In certain of the examples below, a highly purified nitrogen gas was used. The use of highly purified nitrogen gas facilitated product gas analysis. The feed gas can be added continuously or discontinuously, throughout the process. The gases can be free of metal salts and vaporized metals.

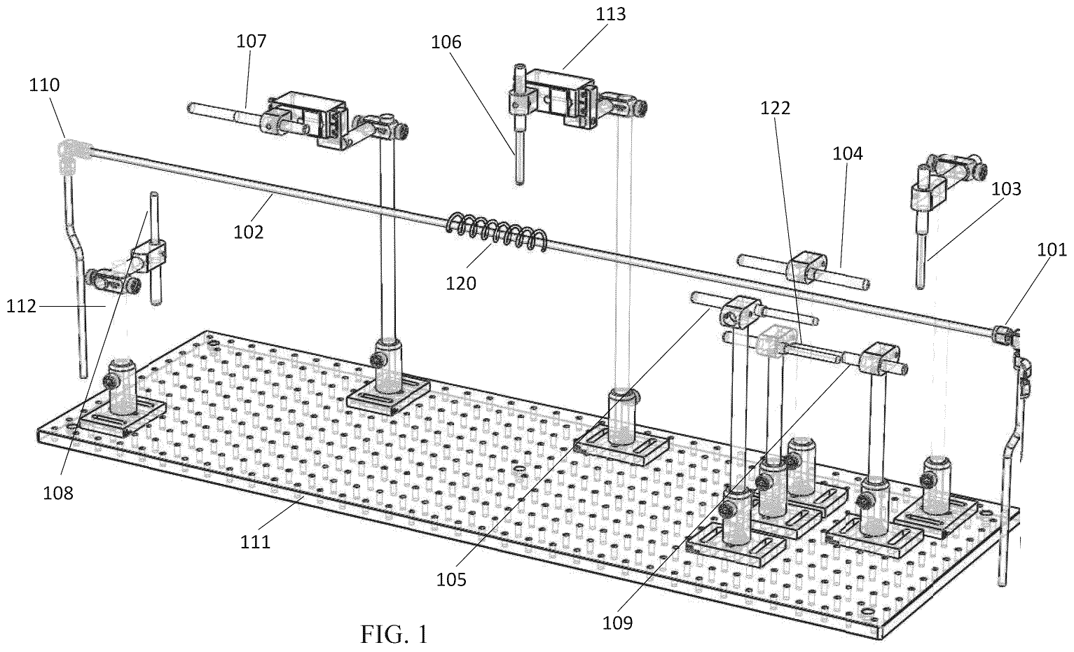

One or more gases (e.g., 2, 3, 4, 5, or more gases) can optionally pass through a gas manifold comprising mass flow meters to produce a feedgas composition, also called the reactor feed gas. The reactor feed gas may then cither by-pass an electromagnetic (EM) embedding enclosure (E/MEE) or pass through one or more E/MEEs. The E/MEE exposes the reactor feed gas to various electromagnetic field (EMF) sources. Flow rates, compositions, and residence times can be controlled. The rate of flow of the reactor feed gas can be between 0.01 standard liters per minute (SLPM) and 10 SLPM, or 100 SLPM or more. A constant flow of gas can maintain a purged environment within the reactor. The schematics shown in FIG. 1 depicts a flow path for the gases through a sample E/MEE. The sample E/MEE comprises a series of lights and coils that can optionally expose the reactor feed gas to EM radiation. EMF sources within the E/MEE can be energized simultaneously or in sequence or a combination thereof.

FIG. 1 is an illustration of an E/MEE of the invention for the production of gaseous chemical reactants. Gas enters the E/MEE via the inlet 101, or entrance, in line 102 and exits at the outlet, or exit, 110. The inlet 101 and outlet 110 may optionally have valves.

Line 102 can be made of a transparent or translucent material (glass is preferred) and/or an opaque or non-translucent material, such as stainless steel or non-translucent plastic (such as TYGON® manufactured by Saint-Gobain Performance Plastics) or a combination thereof. Using an opaque material can reduce or eliminate electromagnetic exposure to the gas as the gas resides within the line. The length of line 102 can be between 50 cm and 5 meters or longer. The inner diameter of line 102 can be between 2 mm and 25 cm or more. Line 102 can be supported on and/or enclosed within a housing or substrate 111, such as one or more plates, with one or more supports 112. For example, substrate 111 can be configured as a plane or floor, pipe or box. Where the substrate is a box, the box can be characterized by a floor, a ceiling and side walls. The box can be closed to and/or insulated from ambient EM radiation, such as ambient light.

One or more lamps (such as 2, 3, 4, 5, 6, 7, 8, 9, 10 lamps or more) can be configured within the E/MEE. Lamps (numbered individually) are preferably pencil lamps characterized by an elongated tube with a longitudinal axis. The pencil lamps can independently be placed such that their longitudinal axes are (i) parallel to the line 102, (ii) disposed radially in a vertical plane to the line 102, or (iii) perpendicular to the plane created along the longitudinal axis of the line 102 or along the vertical axis of the line 102.

Each lamp can, independently, be fixed in its orientation by a support 112. Each lamp can, independently, be affixed to a pivot 113 to permit rotation from a first position. For example, the lamps can be rotated between about 0 and 360 degrees, such as about 45, 90, 135, 180, 225 or 270 degrees, preferably about 90 degrees relative to a first position. The rotation can be with respect to the x, y, and/or z axis wherein (i) the x-axis is defined as the axis parallel to the gas line and its vertical plane, (ii) the y-axis defining the axis perpendicular to the gas line and parallel to its horizontal plane, and (iii) the z-axis is defined as the axis perpendicular to the gas line and parallel to its vertical plane.

Referring to the specific pencil lamps within an E/MEE, line 102 is configured along the E/MEE with gas flowing from the inlet 101 and exiting at the outlet 110. Lamp 103, a neon lamp, is first and is shown above line 102 oriented to be along the z-axis and perpendicular to line 102, with the tip of the lamp pointed towards line 102. Lamp 109, a krypton lamp, is shown below line 102 oriented to be parallel to the x-axis, with the tip pointing towards the outlet 110. Lamps 104 and 105, a long wave and short-wave lamp, respectively, are shown parallel to line 102 oriented to be along the x-axis with the tips pointing towards the inlet. Lamp 122, an argon lamp, is shown to be below line 102 oriented to be parallel to the x-axis, with the tip pointing towards the inlet 101 at approximately the same distance from the inlet as lamps 104 and 105. Lamp 106, a neon lamp, is downstream at about the midpoint of the E/MEE, is above line 102 with the tip pointing down. Lamp 107, a xenon lamp, is shown downstream of lamp 106 above line 102, parallel to the x axis of line 102 and points toward the outlet 110. Lamp 108, an argon lamp, is below line 102 and the tip is pointing toward line 102 along the z-axis. Optional coil 120 is wrapped around line 102. Each of these lamps can be independently rotated, for example, 90 degrees along any axis. Each lamp is connected to a power supply or power source to turn on or off the power. Each lamp can be independently rotated 1, 2, 3, 4 or more times during the process. For convenience, each lamp is held by a pivot that can be controlled by a central processing unit, such as a computer programmed to rotate the pivot and provide power to each lamp. For the case of describing the experimental procedures, each orientation of each lamp is called “position n” wherein n is 0, 1, 2, 3, 4, or more. As the procedure is conducted, each lamp can be powered for specific periods of time at specific amperage(s) and positioned or repositioned.

In the exemplification described below, the initial bulb position for each lamp is described with a degree. A zero-degree) (0° reference point is taken as the 12 o'clock position on the glass pipe when looking down the gas pipe in the direction of intended gas flow (e.g., when looking at the E/MEE exit). The length of the glass pipe or line is taken as the optical length (e.g., in this instance 39 inches). For example, 6 inches from the end is defined as 6 inches from the optical end of pipe.

The lamps can be placed above, below, or to the side (for example, level with the longitudinal axis or a plane parallel to (above or below) the longitudinal axis), for example, of line 102. The lamps can be independently placed anywhere between 5 and 100 cm from the center of the line 102 in the vertical plane, as measured from the tip of the lamp to the center of line 102. One or more lamps can be placed in the same vertical plane along line 102, as illustrated by lamps 122, 104, and 105. Two lamps are in the same vertical plane if they (as defined by the tip or base of the lamp) are the same distance from the inlet 101. Preferably, lamp 105 can be placed in a plurality of (e.g., 2, 3, 4, 5 or more) vertical planes along the length of line 102 within the E/MEE. Further, one or more lamps can be placed in the same horizontal plane above, below or through line 102, as shown with lamps 104 and 105. Two lamps are in the same horizontal plane if they (as defined by the tip or base of the lamp) are the same distance from the center of line 102. Preferably, lamps can be placed in a plurality of (e.g., 2, 3, 4, 5 or more) horizontal planes along the length of line 102 within the E/MEE, as generally illustrated.

It is understood that “pencil lamps,” as used herein, are lamps filled with gases or vapor that emit specific, calibrated wavelengths upon excitation of the vapor. For example, pencil lamps include without limitation argon, neon, xenon, and mercury lamps. For example, without limitation, one or a plurality of lamps can be selected from argon, neon, xenon or mercury or a combination thereof. Preferably, at least one lamp from each of argon, neon, xenon and mercury are selected. Wavelengths between 150 nm and 1000 nm can be selected. One example of a pencil lamp is a lamp characterized by an elongated tube having a tip and a base.

Long wave and/or short-wave ultraviolet lamps can also be used. Pencil lamps used in the E/MEE were purchased from VWR™ under the name UVP Pen_Ray® rare gas lamps, or Analytik Jena in the case of the UV short wave lamps.

A power supply is operably connected to independently to each lamp, E/MEE coil, and frequency generator. The power supply can be AC and/or DC.

The E/MEE can be open or enclosed. Where the E/MEE is enclosed, the enclosure is typically opaque and protects the gas from ambient light. Without limitation, the enclosure can be made of a plastic or resin or metal. It can be rectangular or cylindrical. Preferably, the enclosure is characterized by a floor support.

In baseline experimentation the feed gas can by-pass the E/MEE section and are fed directly to the reactor assembly. The energy levels and frequencies provided by the EM sources can vary.

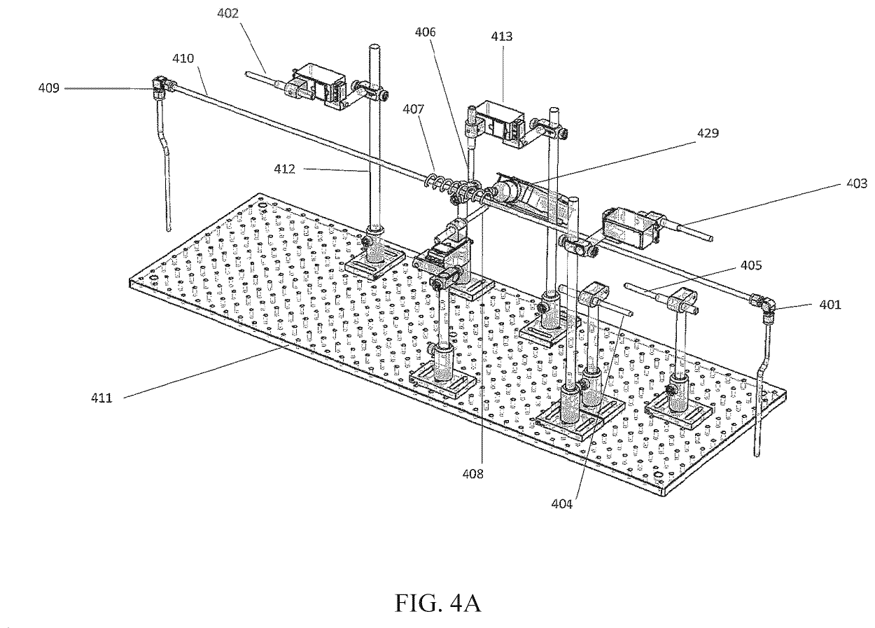

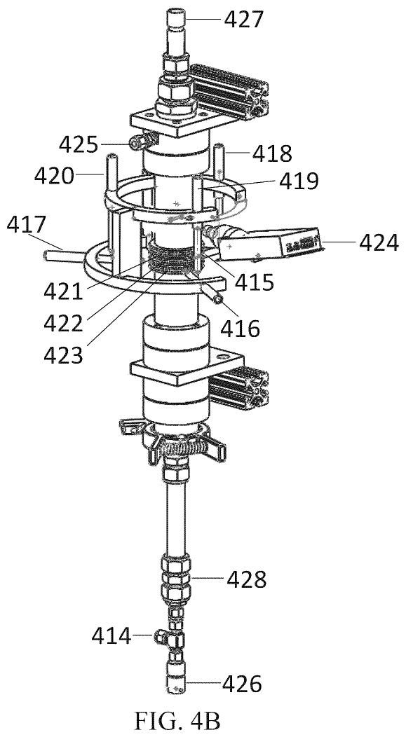

FIG. 4A provides a second illustration of an E/MEE of the invention. Gas enters the E/MEE at inlet 401 and exits at outlet 409 along line 410. Pencil lamp 402 and Pencil lamp 403 are shown parallel to and above line 410 along the vertical plane through line 410 axis. Pencil lamps 404 and 405 are parallel to and below line 410 in the same horizontal plane equidistant from the vertical plane through line 410. Pencil lamp 406 is shown above and perpendicular to line 410, positioned along the z axis. An optional coil 407 is a conductive coil wrapped around line 410. Pencil lamp 408 is shown below and perpendicular to line 410 along the y axis. Substrate 411 provides a base for supports 412. Pivots 413 control the position of each pencil lamp and permit rotation along axis x, y and z. An optional x-ray source 429 is also shown directed towards the coil 407.

The coil 407 is preferably made of conducting material and is connected to a power supply and, optionally, a frequency generator. The coil can comprise copper, aluminum, platinum, silver, rhodium, palladium or other metals or alloys (including braidings, platings and coatings) and can optionally be covered with an insulating coating, such as glyptal. It can be advantageous to use a braid of 1, 2, 3 or more metal wires. The coil can be manufactured from wire typically used in an induction coil and can vary in size and the number of turns. For example, the coil can comprise, 3, 4, 5, 6, 7, 8, 9, 10 or more turns. The inner diameter of the coil can be between 2 cm and 6 cm or more and preferably snugly fits the line 410. An x-ray source 429 can included in the E/MEE. For example, the x-ray source can be directed at line 410 along the line between the inlet 401 and outlet 409. For example, it can be advantageous to direct the x-ray source at coil 407, where present.

### Reactor Assembly (RA):

The invention further relates to a reactor assembly comprising:
A gas inlet and one or more gas outlets;
A reactor chamber, preferably containing a nanoporous carbon material or powder;
A first porous frit defining a floor of the reactor chamber,
A second porous frit defining the ceiling of the reactor chamber; wherein each porous frit has a porosity that is sufficient to allow a gas to permeate into the reactor chamber and contain a nanoporous carbon material;
An optional reactor cup defining side walls of the reactor chamber;
An optional reactor cap positioned above the second porous frit;
A reactor body disposed below the first porous frit;
A reactor head space disposed above the reactor cap;
An optional foil disposed between the reactor chamber and reactor cup;
One or more coils surrounding the reactor body and/or the reactor chamber operably connected to a power supply and/or frequency generator;
An optional x-ray source configured to expose the reactor head space to x-rays;
One or more optional lasers configured to direct a laser towards a frit and/or through the reactor chamber;
A computer processing unit configured to control the power supply, frequency generator, lamps, lasers and x-ray source, when present.

The invention also includes a reactor assembly comprising:
A gas inlet and one or more gas outlets;
A reactor chamber, preferably containing a nanoporous carbon material;
A first porous frit defining a floor of the reactor chamber,
A second porous frit defining the ceiling of the reactor chamber; wherein each porous frit has a porosity that is sufficient to allow a gas to permeate into the reactor chamber and contain a nanoporous carbon material;
A reactor head space disposed above the reactor cap;
2, 3, 4, 5 or more RA coils surrounding the reactor chamber and/or reactor head space operably connected to an RA frequency generator and power supply;
2, 3, 4, 5 or more pairs of lamps wherein the pairs of lamps are disposed circumferentially around the RA coils and define a space between the pairs of lamps and the RA coils;
An optional x-ray source configured to expose the reactor chamber to x-rays;
One or more optional lasers configured to direct a laser through the reactor chamber; and
A computer processing unit configured to control the power supply, frequency generator and the optional x-ray source and lasers.
As previously described, the terms “above,” “floor” and “ceiling” are intended to describe relational spatial features. “Floors” and “ceilings” are typically opposing sides of a space or volume where the head space is adjacent to the “ceiling” and distal to the “floor”, irrespective of the relational geometry to the room or space in which the apparatus resides. In other words, a “ceiling” represents a boundary wall or plane in an assembly confining a space or volume (generally understood as the “top” boundary of such space or volume), while the “floor” represents a boundary wall or plane opposite the ceiling in the same assembly confining the same space or volume (generally understood as the “bottom” boundary of such space or volume). Rotating the assembly on an axis by, for example, 45, 90 or 180 degrees, for example, does not change the relative position of the two planes or assemblies to each other, and such a rotated assembly can still include references to the ceiling or a floor structure thereof as these structures were identified in the assembly prior to such rotation.

The invention also includes a reactor assembly comprising:
A gas inlet and one or more gas outlets;
A reactor chamber, preferably containing a nanoporous carbon material;
A first porous frit defining a floor of the reactor chamber,
A second porous frit defining the ceiling of the reactor chamber; wherein each porous frit has a porosity that is sufficient to allow a gas to permeate into the reactor chamber and contain a nanoporous carbon material;
A reactor head space disposed above the reactor chamber;
An induction coil surrounding the reactor chamber and/or reactor head space operably connected to a power supply; and
A computer processing unit configured to control the power supply. The reactor chamber can optionally contain a cap and/or cup to contain the carbon material.

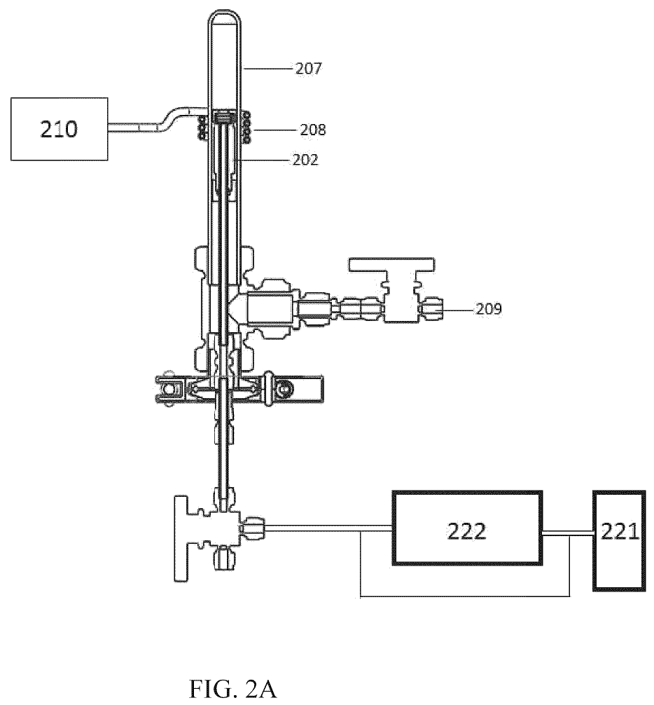

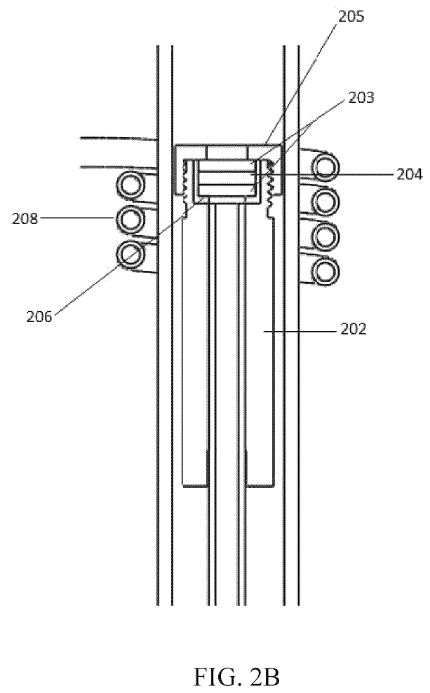

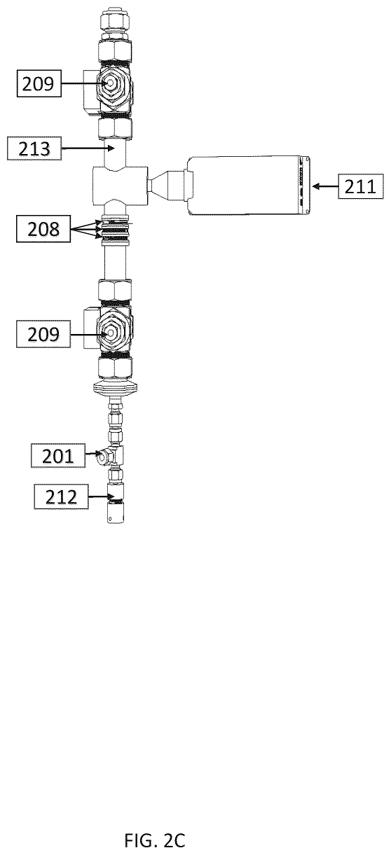

As shown in FIGS. 2A, 2B, and 2C, the reactor assembly comprises a reactor body 202 and starting, or charge, material 204 (which is generally a nanoporous carbon powder) and is located downstream of the gas sources 221 and E/MEE 222, as shown in FIG. 2A. As described above, it is possible for reactor feed gas to bypass the E/MEE. The reactor body 202 can be a packed bed tubular micro-reactor surrounded by one or more conducting coils 208, as illustrated in FIG. 2A, FIG. 2B, and FIG. 2C. FIG. 2A and FIG. 2B show cross sections of the reactor assembly.

The conducting coil 208 can be manufactured from electrically conducting material, such as, without limitation, copper, aluminum, platinum, silver, rhodium, palladium or other metals or alloys (including braidings, platings and coatings) and can optionally be covered with an insulating coating, such as glyptal. The coil can be manufactured from wire typically used in an induction coil and can vary in size and the number of turns. For example, the coil can comprise 3, 4, 5, 6, 7, 8, 9, 10 or more turns. The inner diameter of the coil can be between 2 cm and 6 cm or more and preferably snugly fits the reactor body containment 207.

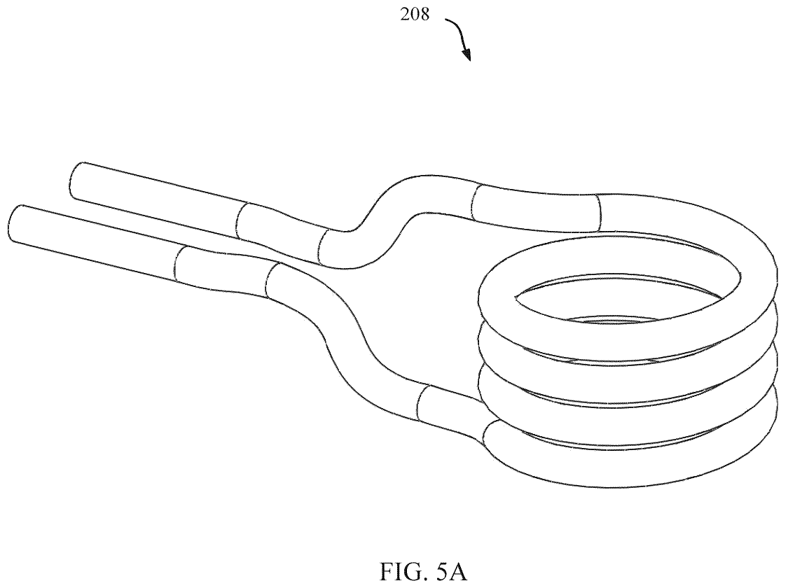

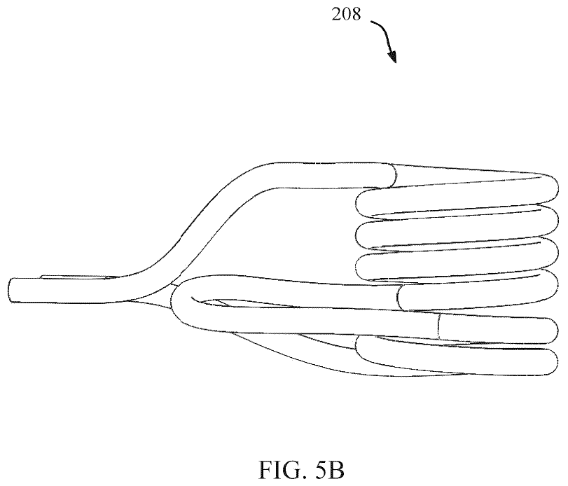

Each conducting coil 208 (or coils) can generate inductive heat and, optionally, a magnetic field. Standard induction coils or reverse field induction coils (coils that have a lower and upper sections connected through an extended arm that allows the sections to be wound in opposite directions, thereby producing opposing magnetic fields) are preferred. The coil 208 can be water-cooled via a heat exchanger. The coil can be connected to a power flange 210, which can be water cooled as well and in turn can connect to a power supply, such as an Ambrell 10 KW 150-400 kHz power supply. In baseline experimentation a standard coil was used with simple copper windings. The windings can form a coil 208 such that the connection to the power supply is at opposite ends of the coil FIG. 5A or the coil can return such that the connection to the power supply is adjacent, as shown in FIG. 5B.

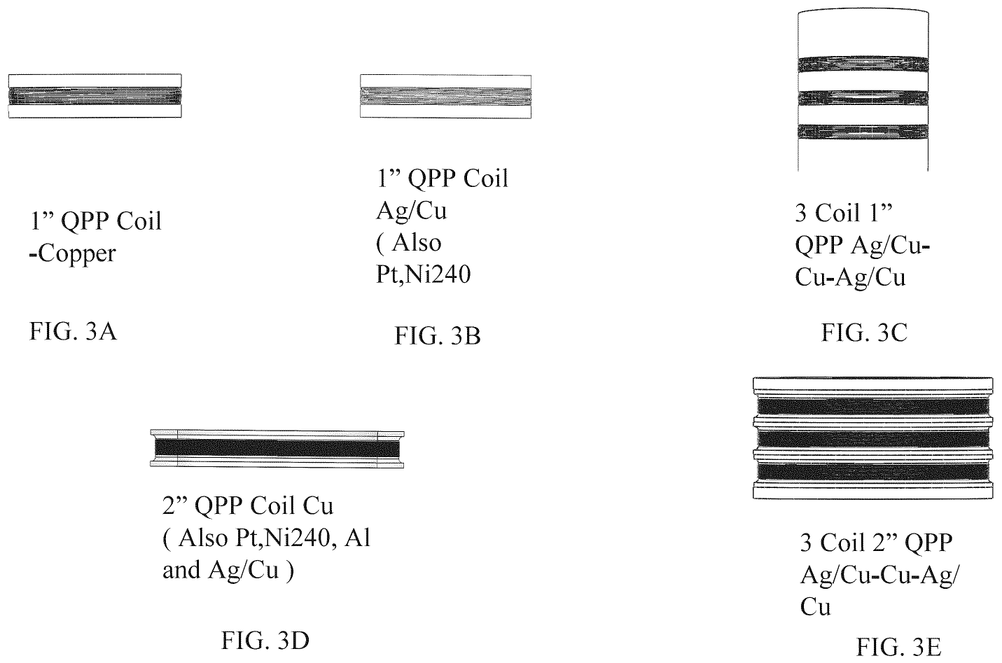

Referring to FIG. 2A, FIG. 2B, and FIG. 2C, the reactor assembly can optionally further comprise one or more coils 208, preferably surrounding the reactor body and its containment system. For example, the reactor assembly can comprise 1, 2, 3, 4, 5, 6, 7, 8, 9, or 10 or more coils, also called RA coils. As shown in FIG. 2B, one or more electromagnetic (E/M) coils can be used to provide magnetic fields. Preferably, 1, 2, 3, 4, or 5 or more E/M coils can be used, more preferably 3, 4, or 5 E/M coils. FIG. 3A-3E shows groupings of three coils, for example, which can generally be numbered 1, 2, or 3, from top to bottom. A grouping of coils, as shown in FIG. 3A-3E, can be called a boundary. Where a plurality of groupings is used, the number of coils used is independently selected. Further, the groupings can be equidistantly spaced along or irregularly spaced.

Coils can be manufactured from electrically conducting materials, such as, without limitation, copper, platinum, silver, rhodium, palladium and, wire braids or coated wires of two or more materials. Each coil in a grouping may be made of the same material or different. For example, a grouping can be made such that each coil is made of a different material. For example, a braiding of copper wire and silver wire can be used. Silver plated copper wire can be used. A first RA coil can be made of a copper winding. A second RA coil can be a copper/silver braid. A third RA coil can be a platinum wire winding. An RA coil can be configured to create a magnetic field and wherein each power supply independently provides AC and/or DC current. Any one or all RA coils can be optionally lacquered.

The coils are preferably circular in geometry. However, other geometries, such as, without limitation, rounded shapes, ellipses and ovoids can be used. The wire diameter can be between about 0.05 mm (> about 40 gauge) and about 15 mm (about 0000 gauge) or more. For example, the wire diameter can be between about 0.08 mm (about 40 gauge) and about 0.8 mm (about 20 gauge) wire. Excellent results have been obtained using 0.13 mm (36 gauge) wire. Coils can be wire windings (e.g., the wire can be wound in 1, 2, 3, 4, 5, 6, 7, 8, 9, 20, or more turns or can be a single turn. In this context, a “wire” can also be considered a band where the width of the material is greater than the depth. FIGS. 3A-E provide illustrations or views of various coils and groupings of coils. A wire coil can be made of a single wire, a wire alloy or two or more wires. For example, two wires comprising different metals can be wound or braided together.

The inner diameter (or dimension(s) where the coil is not a circle) of each coil can be the same or different and can be between 2 and 200 cm.

Coils 208 can independently be connected to one or more power supplies, such as an AC or DC power supply or combination thereof. For example, an AC current can be supplied to alternating (1, 3, and 5, for example) or adjacent coils (1, 2 and/or 4, 5, for example) while DC current is supplied to the remaining coils. Current can be provided (independently) in a frequency, such as in a patterned frequency, e.g., triangle, square or sine pattern or combination thereof. The frequency supplied to each coil can be the same or different and between 0 to 50 MHz or higher. While the coils 208 can generate and transfer thermal energy, or heat, to the reactor feed gas they are predominantly used to create a magnetic field.

The power supply can be an AC and/or DC power supply or combination thereof. Current can be provided (independently) in a frequency, such as in a patterned frequency, e.g., triangle, square or sine pattern or combination thereof. The frequency supplied to each coil can be the same or different and between 0 to 50 MHz or higher, such as between 1 Hz to 50 Mhz.

As described above, the RA coils typically surround the reactor chamber and/or reactor head space. For example, a first RA coil can be aligned with the first (or bottom) frit. A second RA coil can be aligned with the reactor chamber or nanoporous carbon bed. A third RA coil can be aligned with the second (or top) frit. Where present, a fourth RA coil can be disposed between the first RA and the second RA coil. When present, a fifth RA coil can be disposed between the second RA coil and third RA coil. When two or more reactor chambers, or nanoporous carbon beds are present, it can be desirable to add additional RA coils, also aligned with a second or additional reactor chambers or nanoporous carbon beds. Additional RA coils can be added to align with additional frits when present.

The RA coils can typically be supported in a support or stator to maintain a fixed distance between each coil. The support, when present, can be transparent. In one embodiment, the RA coils can be configured in a cartridge that can be removed or moved.

The RA coils can, additionally or alternatively, be aligned with the reactor headspace. The reactor headspace can typically be a volume above the second, or top, frit. It is understood that where the reactor assembly is positioned horizontally (or at some other angle than vertical), the geometry of the spaces is maintained, albeit rotated. The reactor headspace can typically be an enclosed volume. For example, the reactor assembly can be inserted into a closed ended transparent (e.g., glass) tube, vial or bottle. The reactor assembly can be movably engaged with the RA coils (or boundary), thereby permitting each RA coil to align to a different element within the reactor assembly. For example, the first RA coil can be realigned with the reactor chamber.

Referring to FIG. 2A, FIG. 2B, and FIG. 2C, a reactor body 202 can also be a packed, moving, or fluidized bed or other configuration characterized by one or more chambers that receive the charge material 204 and facilitates transfer of a reactor feed gas through the charge material 204 and can transfer thermal and/or electromagnetic energy to the charge material 204. The reactor body 202 is generally contained within a housing, e.g., closed end tube, 207 and frits 203, which function to contain the charge material 204. It can be advantageous to use a reactor within a translucent or transparent housing, such as quartz or other materials characterized by a high melting point. The volume of the reactor bed can be fixed or adjustable. For example, the reactor bed can contain about 1 gram, or less of starting material, between about 1 g to 1 kg of starting material or more. Where the reactor assembly comprises two or more reactor chambers, the reactor chambers are preferably directly or indirectly stacked, preferably having a common central axis and can be separated by one or two frits.

The reactor body 202 can, for example and without limitation, be made of a thermally conductive material, such as graphite, copper, aluminum, nickel, molybdenum, platinum, iridium, cobalt, or niobium, or non-thermally conducting material, such as quartz, plastic (e.g., acrylic), or combinations thereof. An optional cup 206 capped with cap 205 can be advantageous. The cup and cap material can be independently selected. For example, a graphite cup can be combined with a graphite cap, which is the selection for the examples below. A copper cup can be combined with a graphite cap. A graphite cup can be combined with a copper cap. A copper cup can be combined with a copper cap and so on.

The reactor assembly can also receive the gas line through the entrance, or inlet, 201 and to provide an exhaust through an exit, or outlet, 209, optionally controlled by valves. A head space defined by a closed end tube 207 can be configured above the reactor body. The reactor body is preferably made of graphite, copper, or other inorganic rigid material. The gas line is preferably made of an inert tubing, such as glass, acrylic, polyurethane, plexiglass, silicone, stainless steel, and the like can also be used. Tubing can, optionally, be flexible or rigid, translucent or opaque. The inlet is generally below the charge material. The outlet can be below, above or both.

Frits 203 used to define the chamber containing the charge material are also shown. The frits can be made of a porous material which permits gas flow. The frits will preferably have a maximum pore size that is smaller than the particle size of the starting material. Pore sizes of between 2 and 50 microns, preferably between 4 and 15 microns can be used. The thickness of the frits can range satisfactorily between approximately 1 and 10 mm or more. The frits are preferably made of an inert material, such as silica or quartz. Porous frits from Technical Glass Products (Painesville Tp., Ohio) are satisfactory. On the examples below, fused quartz #3 porous frits (QPD10-3) with a pore size between 4 and 15 microns and a thickness of 2-3 microns and fused quartz frits with a pore size between 14 and 40 microns (QPD10-3) were used. The purity of the frits exemplified herein was very high, 99.99% wt, to ensure that the results obtained cannot be dismissed as the result of contamination. Frits of lower purity and quality can also be used. The diameter of the porous frit is preferably selected to permit a snug fit within the reactor interior, or cup. That is, the diameter of the porous frit is approximately the same as the inner diameter of the reactor or cup, if present.

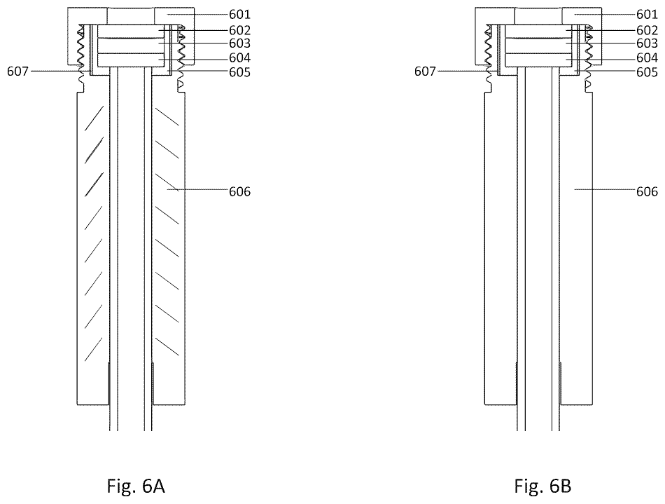

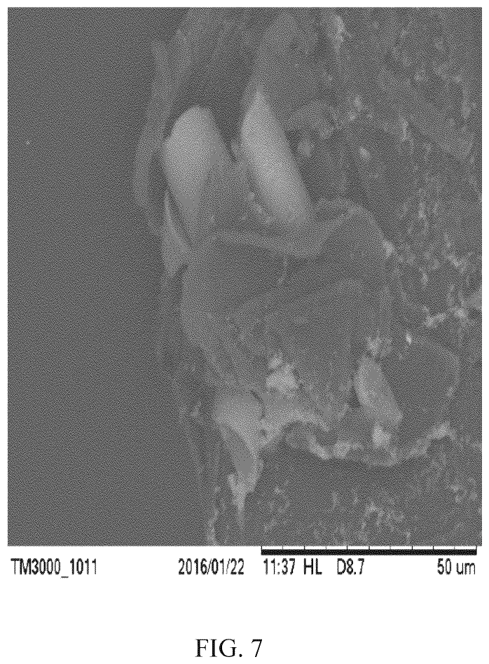

FIGS. 6A and 6B are illustrations of two examples of two composite reactor assemblies. FIG. 6A illustrates a Composite Reactor with a copper reactor body 606, carbon graphite cup 605, and a carbon graphite cap 601 and a metal foil boundary 607. FIG. 6B illustrates a Composite Reactor with a carbon graphite reactor body 606 and cap 601 and metal foil boundary 607. The embodiments depicted in FIG. 6A and FIG. 6B show a top frit 602 and a bottom frit 604, with a graphite bed 603 therebetween. Referring to FIGS. 6A and 6B, a foil 607 can optionally encase the chamber containing the charge material on the inside and/or outside of the frits 602, 604 and/or cup 605, thereby creating a metal boundary surrounding the starting material. The foil 607 can be a metal, such as copper, platinum, niobium, cobalt, gold, silver, or alloys thereof. The foil 607 can also be graphite or the like. The foil 607 can be between 0 and 0.5 cm thick, preferably 1-10 mm. The profile of the reactor can be linear, or it can be configured to contain a constriction below the lower frit, providing the general appearance of a lollipop.

The reactor chamber is sized to contain the desired amount of charge material 204. For the experiments described herein, the chamber is designed to contain between 20 mg to 100 grams of nanoporous carbon powder. Larger reactors can be scaled up.

The reactor assembly may be augmented with additional forms of electromagnetic radiation, such as light. FIG. 4B exemplifies light sources 426 and 427 that generate light directed through the reactor housing 415 and the starting material contained therein. Preferred light sources 426 and 427 can be lasers and/or can emit light in a wavelength between 10 nm and 1 mm. The light is optionally subjected to one or more filters 428, as shown in the use of light sources (beams) in FIG. 4B. Preferably, the reactor assembly comprises 2, 3, 4, 5 or more pairs of lamps disposed circumferentially around the RA coils. Pencil lamps, such as the lamps used within the E/MEE, which is incorporated herein by reference from above, are preferred. The pairs of lamps preferably define a boundary surrounding the coil and are not touching or otherwise adjacent to the coils. Two lamps are considered paired where they are proximal to each other, such as within the same plane with the center axis of an RA coil. Paired lamps can be parallel or orthogonal to each other and the RA coil center axis. Lamps can be considered proximal to each other if the space between any two points between the lamp tip and base is within 10 cm, preferably within 5 cm. Lamps that are positioned orthogonally to the RA coil center axis are generally positioned along the line defined by the radius of one or more RA coils.

The RA lamps, e.g., the pencil lamps proximal to the reactor body, can be matched, or paired, to one or more E/MEE lamps, e.g., the pencil lamps residing within the E/MEE housing and proximal to the gas line. For example, where an E/MEE pencil lamp is a neon lamp, a pair of RA lamps can be neon pencil lamps. Additionally, where an E/MEE pencil lamp is a neon lamp, a pair of RA lamps can be neon pencil lamps. Such matched lamps can emit light characterized by substantially the same wavelength. This can be conveniently achieved by using lamps from the same manufacturer with the same specifications.

The reactor can be in a closed or open housing 415 and can be supported therein by reactor supports. The reactor feed gas is directed to the reactor inlet frit, or bottom frit, directed through the starting material contained within the housing 415 and exits the reactor at the reactor exit frit, or top frit. The reactor feed gas can then be exhausted or recycled, optionally returning to the E/MEE for further treatment.

The reactor can further comprise an x-ray source 211 (FIG. 2C) or 424 (FIG. 4B) and/or one or more lasers 212 (FIG. 2C) or 426 and 427 (FIG. 4B). Preferred x-ray sources include a mini-x. The x-ray is preferably directed through the reactor towards a gas headspace, or target holder 213 (FIG. 2C), above the charge material. The x-ray can be directly or indirectly provided from the source, such as by reflecting the x-ray from a foil disposed above or below a frit.

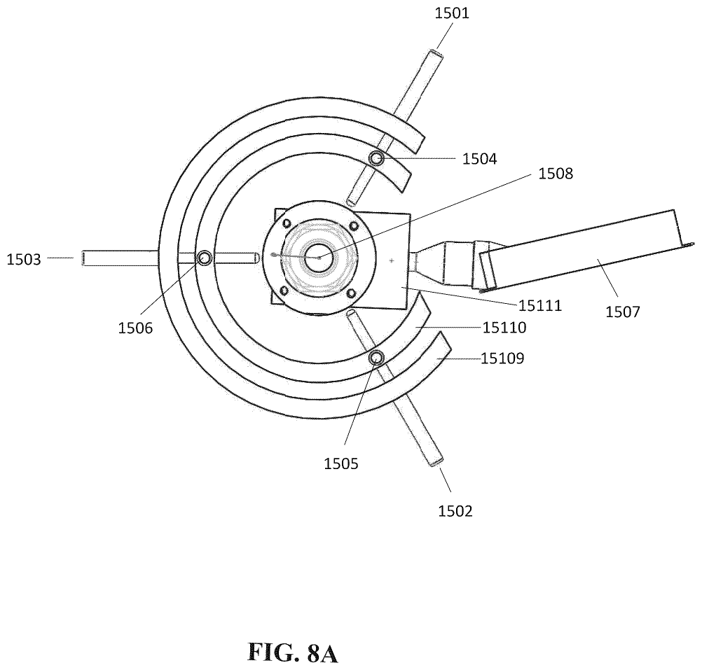

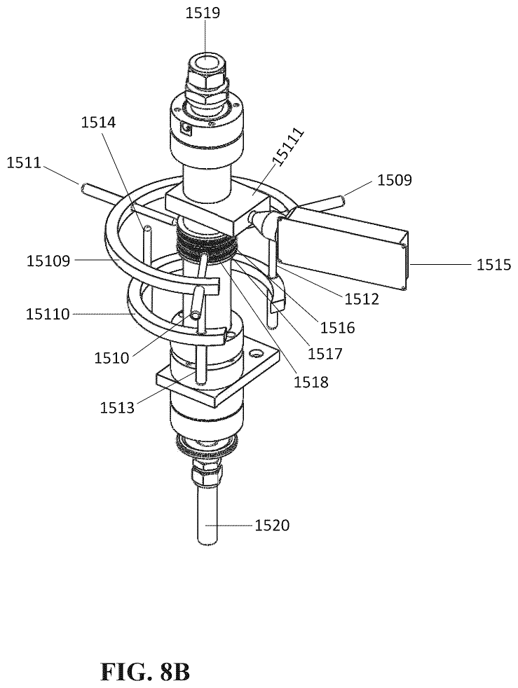

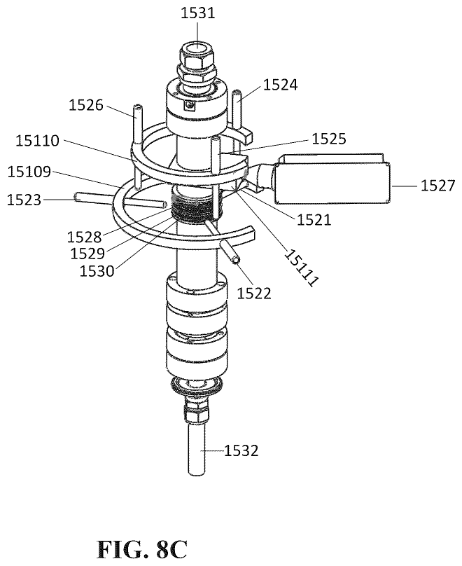

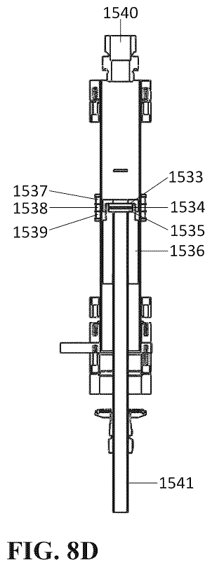

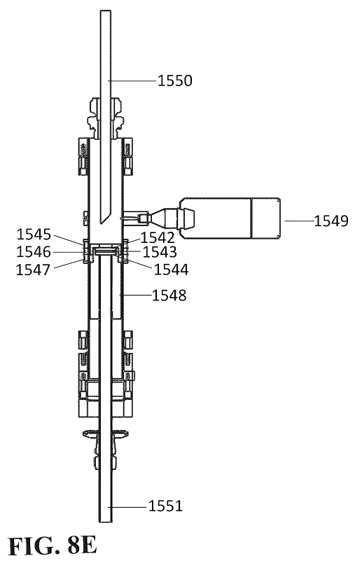

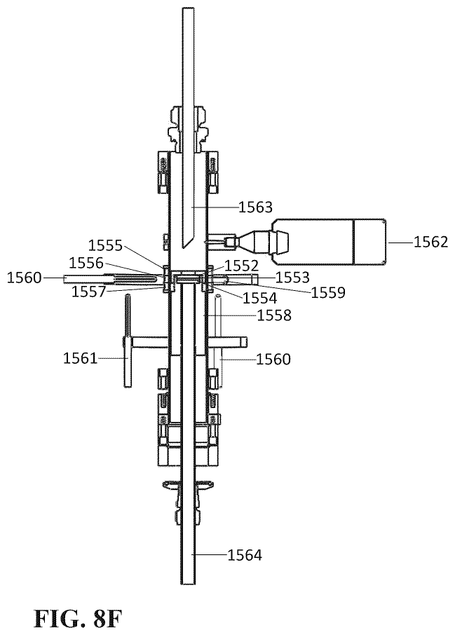

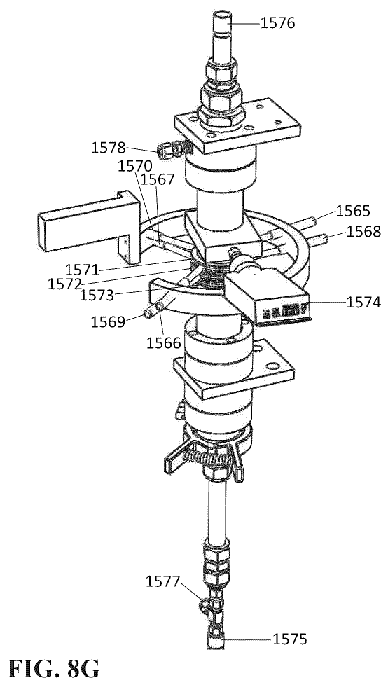

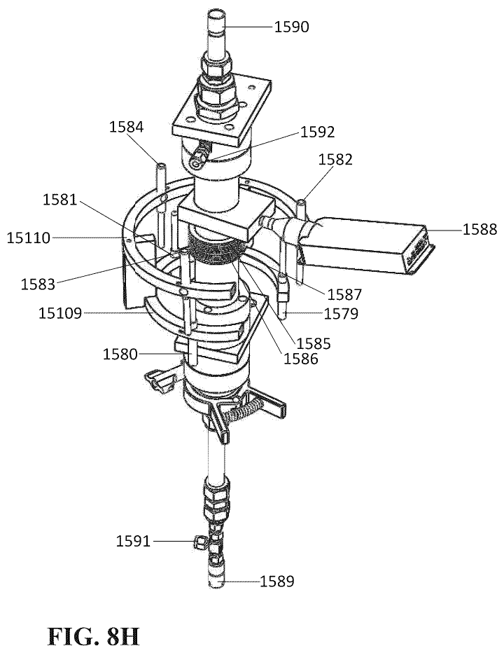

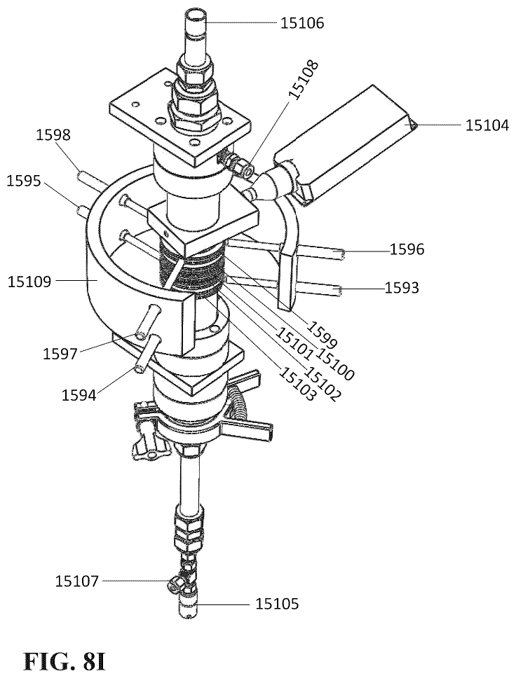

FIG. 8A illustrates a top view of a preferred reactor assembly. Pencil lamp 1501, pencil lamp 1502 and pencil lamp 1503 are shown with the tip directed towards a center axis of the reactor assembly along a radius of the reactor assembly. Pencil lamp 1504, pencil lamp 1505 and pencil lamp 1506 are shown directed parallel to a center axis of the reactor assembly and are disposed in a plane along a radius of the reactor assembly. Pencil lamp 1501, together with pencil lamp 1504, form a first RA lamp pair. Pencil lamp 1502, together with pencil lamp 1505, form a second RA lamp pair. Pencil lamp 1503, together with pencil lamp 1506, form a third RA lamp pair. As with the E/MEE pencil lamps, each RA lamp can be rotated along its x, y or z axis. Each pair can optionally reside within the same radial plane, as shown. Outer support 15109 provides support for the pencil lamps 1501, 1502 and 1503. Inner support 15110 provides support for the pencil lamps 1504, 1505 and 1506. The outer and inner supports are preferably made of non-conductive materials (such as polymers or resins) and are preferably transparent. An optional x-ray source 1507 is shown directing x-rays towards the center axis of the reaction chamber 1508. Reactor connector 15111 is also shown.

FIG. 8B is a perspective view of this reactor assembly. Pencil lamp 1509, pencil lamp 1510 and pencil lamp 1511 are shown directed with the tip towards a center axis of the reactor assembly along a radius of the reactor assembly. The tip of each lamp aligns with the center, or third, RA coil 1517 and is in the same horizontal plane. Pencil lamp 1512, pencil lamp 1513 and pencil lamp 1514 are shown directed parallel to a center axis of the reactor assembly, disposed in a plane along a radius of the reactor assembly and is characterized by a tip pointing towards top of the reactor, away from the gas inlet 1520. These lamps are illustrated above the horizontal pencil lamps. The length of each pencil lamp align with RA coils 1516, 1517 and 1518. Outer support 15109 and inner support 15110 support the pencil lamps. An optional x-ray source 1515 is shown directing x-rays towards the center axis of the reactor assembly above the third RA coil 1516. Disposed within the reactor assembly can be a reflecting plate to direct the x-ray towards the reaction chamber. Reactor connector 15111 is also shown, as well as other non-material connectors and spacers. Gas inlet 1520 and gas outlet 1519 are also shown.

FIG. 8C is a second perspective view of a reactor assembly. Pencil lamp 1521, pencil lamp 1522 and pencil lamp 1523 are shown directed with the tip towards a center axis of the reactor assembly along a radius of the reactor assembly. Pencil lamp 1524, pencil lamp 1525 and pencil lamp 1526 are shown directed parallel to a center axis of the reactor assembly, disposed in a plane along a radius of the reactor assembly and is characterized by a tip pointing towards the bottom of the reactor, towards the gas inlet 1532. These vertical lamps are shown above the horizontal lamps and, again, each pair of lamps can optionally lie in the same radial plane. The tip of each pencil lamp aligns with the third RA coil 1528. Outer support 15109 and inner support 15110 support the pencil lamps. Three RA coils 1528, 1529 and 1530 are shown. An optional x-ray source 1527 is shown directing x-rays towards the center axis of the reactor assembly. Disposed within the reactor assembly can be a reflecting plate to direct the x-ray towards the reaction chamber. Reactor connector 15111 is also shown, as well as other non-material connectors and spacers. Gas inlet 1532 and gas outlet 1531 are also shown.

FIG. 8D is a cross sectional side view of the reactor assembly, stripped of the pencil lamps and x-ray source. Gas enters at the inlet 1541 and exits at the outlet 1540. RA coils 1537, 1538 and 1539 are shown. The first, or bottom, frit 1535 and the second, or top, frit 1533 contain the reaction chamber 1534, which can be charged with nanoporous carbon powder. The reactor body 1536 is also shown. Other non-material spacers and connectors remain unlabeled.

FIG. 8E is a second cross sectional side view of a reactor assembly, stripped of the pencil lamps and x-ray source. Gas enters at the inlet 1551. RA coils 1545, 1546 and 1547 are shown. The first, or bottom, frit 1544 and the second, or top, frit 1542 contain the reaction chamber 1543, which can be charged with nanoporous carbon powder. The reactor body 1548 is also shown. X-ray source 1549 directs x-rays towards the center axis of the reactor assembly which is then deflected towards the reactor chamber with element 1550. Other non-material spacers and connectors remain unlabeled.

FIG. 8F is a second cross sectional side view of a reactor assembly with the pencil lamps and x-ray source. Gas enters at the inlet 1564. RA coils 1555, 1556 and 1557 are shown. The first, or bottom, frit 1554 and the second, or top, frit 1552 contain the reaction chamber 1553, which can be charged with nanoporous carbon powder. The reactor body 1558 is also shown. Vertical pencil lamps 1560 and 1561 are shown as are horizontal pencil lamps 1560 and 1559. X-ray source 1562 directs x-rays towards the center axis of the reactor assembly which is then deflected towards the reactor chamber with element 1563. Other non-material spacers and connectors remain unlabeled.

FIG. 8G is a perspective view of a reactor assembly with the pencil lamps and x-ray source. Gas enters at the inlet 1577 and exits at outlet 1578. A first laser 1575 and a second laser 1576 directing radiation towards the reaction chamber along the axis of the reactor assembly is shown. RA coils 1571, 1572 and 1573 are shown. In this embodiment, pencil lamps 1565, 1566, 1567, 1568, 1569, and 1570 are all shown horizontally disposed in pairs along the radius towards the reactor assembly central axis. Tips are proximal to RA coils 1571, 1572 and 1573. X-ray source 1574 directs x-rays towards the center axis of the reactor assembly. Support 15109 (FIG. 8A) supports all of the horizontal pencil lamps. Other non-material spacers and connectors remain unlabeled.

FIG. 8H is a perspective view of a reactor assembly with the pencil lamps and x-ray source. Gas enters at the inlet 1591 and exits at outlet 1592. A first laser 1589 and a second laser 1590 directing radiation towards the reaction chamber along the axis of the reactor assembly is shown. RA coils 1585, 1586 and 1587 are shown. In this embodiment pencil lamps 1579, 1580, 1581, 1582, 1583, and 1584 are all shown vertically disposed in pairs in radial planes aligned with the RA coils. Tips are proximal to RA coils 1585, 1586 and 1587. X-ray source 1588 directs x-rays towards the center axis of the reactor assembly. Supports 15109 and 15110 support the pencil lamps. Other non-material spacers and connectors remain unlabeled.

FIG. 8I is a perspective view of a reactor assembly illustrating 5 RA coils, horizontal pencil lamps and an x-ray source. Gas enters at the inlet 15107 and exits at outlet 15108. A first laser 15105 and a second laser 15106 directing radiation towards the reaction chamber along the axis of the reactor assembly is shown. RA coils 1599, 15100, 15101, 15102 and 15103, defining a cyndrical boundary, are shown. In this embodiment pencil lamps 1593, 1594, 1595, 1596, 1597, and 1598 are all shown horizontally disposed in pairs in radial planes aligned with the RA coils. Tips are proximal to RA coils 1599 and 15103. X-ray source 15104 directs x-rays towards the center axis of the reactor assembly. Support 15109 supports the pencil lamps. Other non-material spacers and connectors remain unlabeled.

i. Ni-1 Reactor:

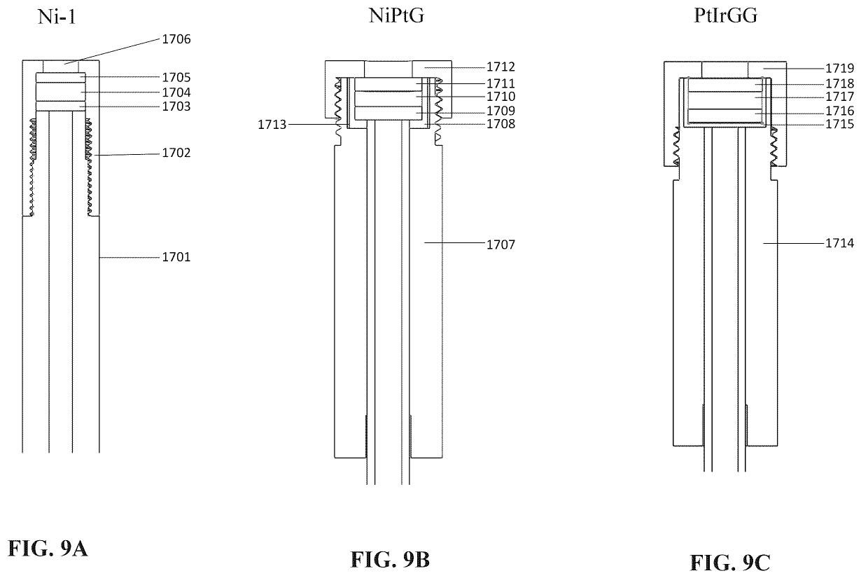

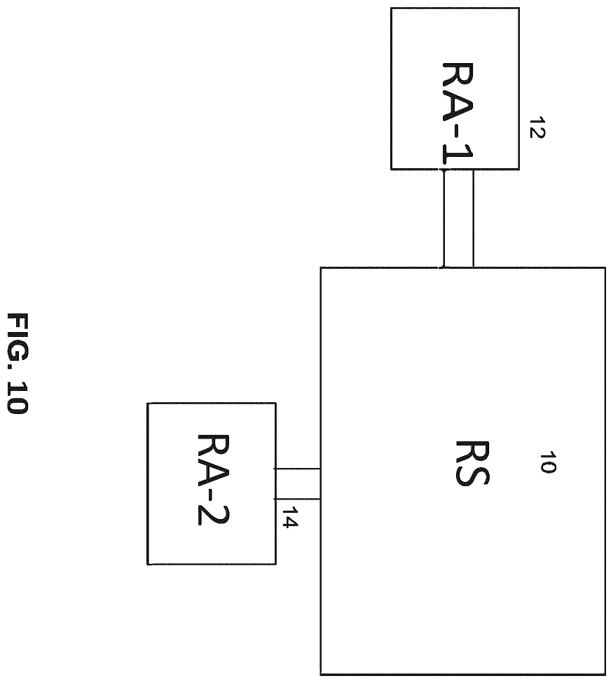

Referring to FIG. 9A, the reactor body (1702) is based on a high purity nickel (Ni) rod. The Ni rod, with an outside diameter of 15.873 mm (OD) is bored through then machined with a female thread on one end. The inside diameter allows for the installation of upper and lower frit and carbon bed. The carbon reaction medium is housed inside the reactor body (1702). To load the reactor, the reactor body (1702) is positioned with the gas discharge opening (1706) facing down on a flat surface. A quartz frit (1705) is placed inside the reactor body (1702) to form the upper containment. 100 mg of carbon is then loaded into the reactor body (1702). After loading of the graphite bed inside the reactor body (1702), a second quartz frit (1703) is installed. A reactor pole (1701), machined out of a high purity graphite rod with matched male threads for the reactor body (1702), is then screwed onto the reactor body (1702). The reactor pole (1701) is designed to allow and provide for graphite bed compression (1704) equivalent to that provided by the cup design (1710 in FIG. 9B and 1717 in FIG. 9C).

ii. NiPtG Reactor:

Referring to FIG. 9B, in the NiPtG Reactor embodiment, the reactor body (1707) is based on a high purity nickel (Ni) rod. The Ni rod, with an outside diameter of 15.873 mm (OD) is bored through then machined on one end to have an inside diameter of 11.68 mm (ID). The inside diameter allows for the installation of a graphite cup (1708) and an optional 0.025 mm platinum (Pt) foil (1713). The graphite cup provides for reactor wall and foil isolation from the carbon bed. The carbon reaction medium is housed inside a 99.9999 wt % pure graphite cup (1708). To load the reactor, a quartz frit (1709) is placed inside the graphite cup (1708) to form the bottom containment. 100 mg of carbon (1710) is then loaded into the cup (1708). After loading of the graphite bed inside the cup, a second quartz frit (1711) is installed; this system is defined as the cup assembly. Prior to installing the cup assembly, the foil (1713) is used to line the inside surface of the reactor wall. The cup assembly is then placed within the nickel reactor body (1707) and foil (1713). After the cup assembly is installed, a 99.9999_{wt}% pure graphite cap (1712) is screwed onto the reactor body. The cap secures the cup from movement after assembly.

iii. PtIrGG Reactor:

Referring to FIG. 9C, the reactor body (1714) is based on a high purity graphite rod. The graphite rod, with an outside diameter of 15.873 mm (OD) is bored through then machined on one end to have an inside diameter of 11.68 mm (ID). The inside diameter allows for the installation of a graphite cup (1715) for reactor wall isolation from the carbon bed. The carbon reaction medium is housed inside a 99.9999 wt % pure graphite cup (1715). To load the reactor, a quartz frit (1716) is placed inside the graphite cup to form the bottom containment. 100 mg of carbon (1717) is then packed into the cup. After loading of the graphite bed inside the cup, a second quartz frit (1718) is installed; this system is defined as the cup assembly. The cup assembly is then placed within the graphite reactor body (1714). After the cup assembly is installed, a cap (1719) composed of platinum and 10% wt iridium is screwed onto the reactor body. The cap secures the cup from movement after assembly.

The residence time of the starting material within the reactor is effective to instantiate, or filter, or isolate, or extract, or nucleate, product into the starting material and can be between 0 and 15 minutes or more.

Preferred reactors used in the methods of the invention are shown in the table below.

TABLE 1

| Reactor | Cup | Cap | Reactor | Pole | | Chamber | | |
|---|---|---|---|---|---|---|---|---|
| ID | Material | Material | Material | Material | Boundary | Capacity | | Coil Type |
| CgF | N/A | N/A | Cu, Ni | graphite | N/A | 100 | mg | Induction |
| | | | or Mo or | | | | | |
| | | | graphite | | | | | |
| CuG | Graphite | graphite | Cu | quartz | N/A | 100 | mg | Induction or |
| | | | | | | | | Frequency |
| PtIrGG | Graphite | Pt/Ir | graphite | quartz | N/A | 100 | mg | Induction |
| GPtG | Graphite | graphite | graphite | quartz | Pt | 100 | mg | Induction or |
| | | | | | | | | Frequency |
| GPtGPtG | Graphite | graphite | graphite | quartz | 2X Pt | 100 | mg | Induction |
| GG-EL | Graphite | graphite | graphite | quartz | N/A | 100 mg-3 g | | Induction or |
| | | | | | | | | Frequency |
| Foil (Pt) | Graphite | graphite | graphite | quartz | Pt | 100 | mg | Induction or |
| | | | | | | | | Frequency |
| GZ Foil | Graphite | graphite | graphite | quartz | Nb, Co or | 100 | mg | Induction or |
| | | | | | Pt | | | Frequency |
| nZG Foil | Graphite | Any Z | graphite | quartz | Ir | 100 | mg | Induction or |
| | | | | | | | | Frequency |
| NiG | Graphite | graphite | Ni | quartz | N/A | 100 | mg | Induction or |
| | | | | | | | | Frequency |
| NiPtG | Graphite | graphite | Ni | quartz | Pt | 100 | mg | Induction |
| ZG | N/A | Pd/Ru or | graphite | quartz | N/A | 100 | mg | Induction |
| | | any Z | | | | | | |
| Ref-X | Graphite | graphite | graphite | quartz | N/A | 1-20 | g | Frequency. |

The invention further relates to methods of instantiating materials, including elemental metals, in nanoporous carbon powders. It has been surprisingly found that light elements, such as hydrogen, oxygen, helium, and the like are instantiated, or filtered, or isolated, or extracted, or nucleated. Instantiating is defined herein to include the nucleation and assembly of atoms within carbon structures, particularly, ultramicropores. Without being bound by theory, it is believed instantiation is related to, inter alia, degrees of freedom of the electromagnetic field as expressed by quantum field theory. By exposing a gas to harmonic resonances, or harmonics, of electromagnetic radiation within one or more ultramicropores, vacuum energy density is accessed and allows for the nucleation and assembly of atoms. Electromagnetic energy that is within the frequencies of light, x-rays, and magnetic fields subjected to frequency generators can enhance the formation and maintenance of such harmonics. Modifying the boundaries of the system, by selecting the reactor materials and adding a foil layer can also enhance the harmonics.

In particular, the invention includes processes of producing, or instantiating, nanoporous carbon compositions comprising the steps of:
adding a nanoporous carbon powder into a reactor assembly as described herein;
adding a feed gas to the reactor assembly;
powering the one or more RA coils to a first electromagnetic energy level;
heating the nanoporous carbon powder;
harmonic patterning the nanoporous carbon powder between a first electromagnetic energy level and a second electromagnetic energy level for a time sufficient to instantiate, or filter, or isolate, or extract, or nucleate, a chemical reactant, which can be an elemental metal, in a nanopore and, optionally, collecting the chemical reactant.

The invention includes a process for producing a chemical reactant comprising the steps of:
(a) adding a feed gas to an electromagnetic embedding apparatus:
(b) exposing the feed gas to at least one E/MEE light source;
(c) directing the feed gas from step (b) to a reactor assembly comprising:
   A gas inlet and one or more gas outlets;
   A reactor chamber containing a nanoporous carbon disposed within a cup and, optionally, covered with a cap;
   A first porous frit defining a floor of the reactor chamber disposed within the cup, A second porous frit defining the ceiling of the reactor chamber; wherein each porous frit has a porosity that is sufficient to allow a gas to permeate into the reactor chamber;
   A reactor head space disposed above the reactor chamber;
   At least one RA coil surrounding the reactor chamber and/or reactor head space operably connected to a power supply, wherein the computer processing unit is configured to control the power supply to the RA coil;
(d) subjecting the nanoporous carbon powder to harmonic patterning to instantiate, or filter, or isolate, or extract, or nucleate, the chemical reactant integrated within a product composition;
(f) collecting the product composition comprising the chemical reactant; and
(g) isolating the chemical reactant from the product composition.

The invention further includes processes of instantiating metal atoms on nanoporous carbon compositions comprising the steps of:
adding a nanoporous carbon powder into a reactor assembly as described herein;
adding a gas to the reactor assembly;
powering the one or more RA coils to a first electromagnetic energy level;
heating the nanoporous carbon powder;
harmonically patterning the nanoporous carbon powder between a first electromagnetic energy level and a second electromagnetic energy level for a time sufficient to instantiate, or filter, or isolate, or extract, or nucleate, an elemental metal nanostructure in a nanopore.

The term “harmonic patterning” is defined herein as oscillating between two or more energy levels (or states) a plurality of times. The energy states can be characterized as a first, or high, energy level and a second, or lower, energy level. The rates of initiating the first energy level, obtaining the second energy level and re-establishing the first energy level can be the same or different. Each rate can be defined in terms of time, such as over 1, 2, 3, 4, 5, 6, 7, 8, 9, 10 or more seconds. Each energy level can be held for a period of time, such as 1, 2, 3, 4, 5, 6, 7, 8, 9, 10 or more seconds. Harmonic patterning is continued until instantiation is achieved.

Where two more electromagnetic radiation sources are present (e.g., coils, x-ray source, lasers, and/or lamps), each can be subjected to harmonic patterning and the patterning can occur independently, simultaneously or sequentially.

The process further comprises independently powering any additional electromagnetic radiation source, as described above in the E/MEE apparatus or reactor assembly. For example, the process further comprises the step(s) of powering RA frequency generator(s) connected to one or more RA coils, one or more lamps or lasers, x-ray sources, induction coils, E/MEE coils, and the like substantially as described above.

b. Use Cases for Chemical Reactants

Methods and and apparatus for producing chemical reactants in accordance with these inventions can be appreciated in more detail by reference to the following description and Figures.

i. General Use Cases

While a reactor assembly (RA) as disclosed herein can instantiate, or filter, or isolate, or extract, or nucleate, a chemical product that can be collected and commercialized separately, for example for use in conventional chemical reactions, a RA as disclosed herein can also interface with a system within which a chemical reaction can take place, which chemical reaction utilizes the chemical reactant(s) produced by the RA. Such a system for utilizing chemical reactants to support chemical reactions can be termed a “reaction system,” (RS) and it can comprise an apparatus or enclosure within which a chemical reaction takes place. The term “reaction system” is not limited to closed vessels for reactions, since it is understood that certain chemical reactions such as flame combustion do not require a closed system but can occur in “the open.” As described previously, a RA produces a chemical reactant that can be supplied to a RS; one or more RAs can produce one or more chemical reactants, to be used by one or more RSs.

In the exemplary embodiment shown schematically in FIG. 10, a plurality of RAs, (RA-1, 12 and RA-2, 14) can produce the same or different substances, to be supplied to RS 10. As an example, one RA can produce a metallic chemical reactant such as calcium while the other RA can produce a chemical reactant useful as an oxidizing agent therefor (e.g., O₂). These chemical reactants (such as the metallic chemical reactant and the oxidizing agent) can be conveyed into the RS 10, where the designated reaction takes place, advantageously producing other reaction products that can be beneficially employed, such as metal oxides. RAs such as RA-1 (12) and RA-2 (14) are capable of instantiating a desired chemical substance(s) or mixture of chemical substances, including but not limited to simple mono-elemental atoms and molecules (e.g., alkali metals such as Na, alkaline earth metals such as Ca, H₂, O₂, halogen molecules such as Cl₂, etc.), simple multi-elemental molecules comprising at least two elements (e.g., CO, NH₃ or H₂O₂, CaO, etc.), or complex multi-elemental molecules comprising at least two elements in various distinguished configurations (e.g., hydrocarbons, carbohydrates, alcohols, etc.). As depicted in FIG. 10, the RAs 12 and 14 can be coupled to any RS apparatus 10 that can immediately, or almost immediately, or at other timing, carry out chemical reactions between the chemical reactant produced by RA-1 and RA-2 to yield useful reaction products.

Depending on the particular embodiment, the RS 10 can comprise, without limitation: (i) an apparatus that consumes a chemical substance; or (ii) a reactant-transformation system and process that uses a chemical reactant as a feedstock or precursor in the production of other chemicals or materials, (iii) a storage facility that stores the chemical reactant produced by the RA(s) 12 and 14, or any combination of the foregoing.

These various dispositions of chemical substances such as reductants or oxidants may be generalized by the concept of “reductant sink” and “oxidizer sink”. Accordingly, the output(s) of such RA(s) 12, 14 in some embodiments is/are directed through a “conduit” to a “reductant sink” or an “oxidizer sink” which receives the reductant or oxidizer and processes it. This may be further generalized by the term “sink” to refer to any storage or utilization means which consumes, uses, processes, stores, transforms, or otherwise receives substances produced by RA(s). Occasionally this may include inert, or filler, or buffer elements which may be used to moderate or otherwise temper a reaction without themselves actually undergoing chemical transformation.

Systems incorporating one or more RAs in communication with one or more RSs can include one or more chemical transformers. For example, RAs 12 and/or 14 can be coupled to a storage facility apparatus whereby the chemical substance(s) can be retained for use elsewhere or later; or can be moved through a conduit for other processing such as being used as a feedstock or precursor to the production of other chemicals.

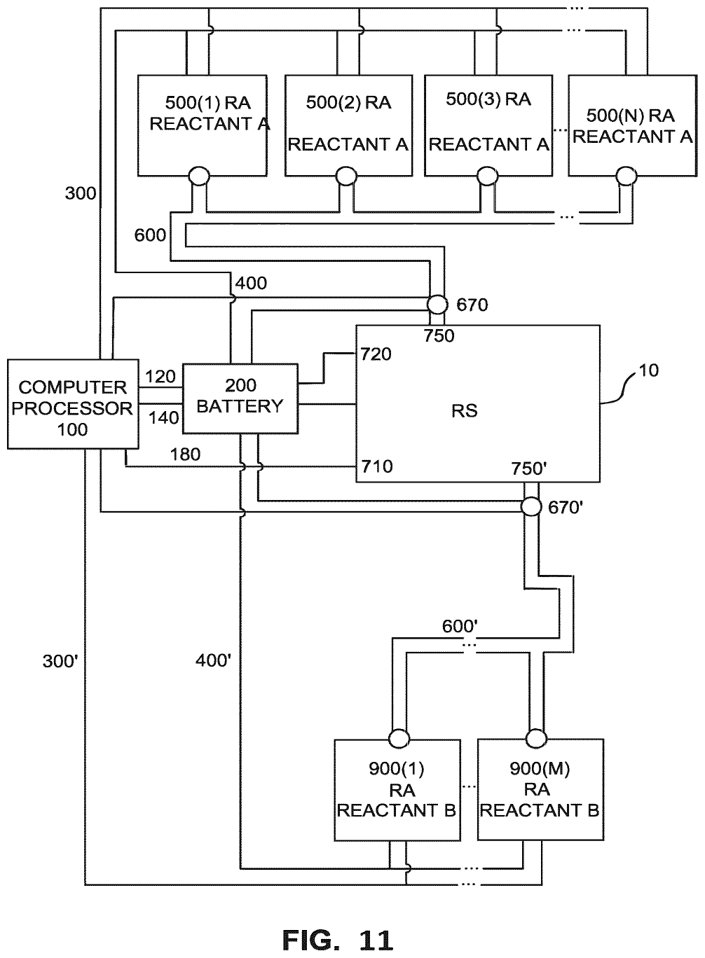

In embodiments, a plurality of RAs can be harnessed to form an integrated system delivering appropriate quantities of chemical reactants to a RS in order to achieve a desired reaction. Such a system is illustrated in FIG. 11. FIG. 11 depicts a series of RAs 500(1-n) that supplies a chemical substance to a RS 10 via a conduit 600. In the example shown, “N” RA(s) 500(1), 500(2), . . . , 500(N) (where N is any positive integer) may be configured to assemble the reactants in sufficient quantities appropriate for the reactants and deliver the reactants to the reaction chamber, i.e., RS 10.

In the depicted example, “M” RAs(s) 900 (where M is zero or any positive integer) can be configured to assemble a second chemical substance, such as a chemical reactant appropriate for the fuel sink and deliver the chemical substance to the reaction chamber RS 10. It is understood that the RA bank or set 900(1)-900(M) is optional, to be used in systems where a second chemical substance is to be provided to the RS in addition to the chemical substance produced by the RA bank or set 500(1)-500(n). Any number of additional RAs or banks or sets of RAs may be provided to supply any number of and quantity of chemical substances individually, alternately, simultaneously or in any desired mixtures or ratios, to RS 10.

The chemical substances produced by RAs 500, 900 are supplied to RS 10 via one or more conduits 600, 600′. As material moves between points it is said to move through a “conduit”. Examples of such materials include without limitation: hydrogen, ammonia (NH₃), hydrocarbons, alcohols (as fuels); oxygen, ozone, hydrogen peroxide (H₂O₂), (as oxidants); helium, xenon, argon, krypton, (as elements to moderate or buffer the reaction); nitrogen, other gases, fuels, oxidizing agents, boron, calcium, aluminum, and any other elements or compounds used within the system. Depending on an implementation's design and engineering constraints, a “conduit” may vary from being a trivial, almost abstract, connection to a complicated path in which a number of operations are performed, sometimes conditionally, on the subject material. Such operations may include, for example and without limitation, being: pumped, collected, combined, e.g., combined with the output of other conduits or sources, pressurized, compressed, liquefied, solidified, stored, packaged, transported, hauled, unpackaged, repackaged, gasified, uncompressed, depressurized, filtered, mixed, agitated, centrifuged, shaken, oscillated, stirred, vibrated, gated, shunted, injected, diverted, merged, blown, aerated, propelled, spun, blended, dissolved, extracted, sensed, tested, humidified, dehumidified, monitored, measured, regulated, accumulated, cooled, heated, or otherwise processed. Such operations may involve the use of components including for example and without limitation: pumps, sensors, gates, shunts, injectors, valves, baffles, pipes, splitters, plumbing, relays, filters, controls, accumulators, tanks, containers, reservoirs, fans, blowers, propellers, impellors, aerators, agitators, oscillators, vibrators, shakers, stirrers, centrifuges, pressurizers, humidifiers, dehumidifiers, compressors, refrigerators, blenders, mixers, vats, dissolvers, extractors, coolers, heaters, gasifiers, liquefiers, and sensors and controls for flow, humidity, concentration, density, purity, particle size, particle diameter, particle surface area, particle weight, viscosity, temperature, volume, and pressure, as well as other sensors and controls and processing equipment. Each operation may be performed zero or more times, sometimes simultaneously, and the order in which they are performed (and whether they are appropriate or necessary) depends on a particular implementation's design, tradeoffs, and constraints. Conduits may also be used to route power and signal cables. A conduit 600, 600′ may thus without limitation comprise a single pipe or other structure capable of conducting fluids (preferably gases), a conveyor for conducting powders or solids, a blower system for moving powders or gas. a manifold that couples the outputs of multiple RAs 500, 600 together as a bank or set of RAs, a mixer that mixes the outputs of multiple RAs together, or any other suitable structure for conveying outputs of RAs 500, 900 to RS 10. As shown in FIG. 11, a conduit can act as a fuel intake manifold for delivering the instantiated chemical reactants to the RS 10. The conduit(s) 600, 600′ may also convey reactants provided by another reactant source, for example, a storage tank or other production process such as e.g., electrolysis. Such additional source(s) could be used in some embodiments and/or under some operating conditions in addition to RA(s) 500, 900 to provide sufficient quantities of primary or secondary reactants to meet demands of the RS 10. For example, RA(s) 500, 900 may operate for an extended period of time to develop substances for storage in storage tanks, and RS 10 may later consume the substances stored in the storage tanks.

Delivery of chemical reactants from RAs to the one or more RSs can be coordinated by control systems that monitor aspects of the overall system, and that regulate the flow of materials through the different components of the overall system. In the embodiment depicted in FIG. 11, aspects of each RA 500, 900 are monitored and regulated by processor 100 through bus 300/300′, which may comprise a digital data bus in one embodiment. The various monitored aspects may include, without limitation, power, temperature, humidity, configuration, pressure, flow, concentration, viscosity, density, purity, particle dimension, and any other relevant state or parameter; together with the operation of fans, blowers, oscillators, pumps, valves, reservoirs, accumulators, pressurizers, compressors and/or other devices used to support the processes shown. The processor 100 may also send signals over bus 300/300′ to control aspects of the state and operation of each RA 500, 900, and conduits 600, 600′ such as flow control, output rate, and any other relevant state, parameter or characteristic. As shown in FIG. 11, computer processor 100 provides an electronic controller that senses, monitors, coordinates, regulates, and controls the various aspects of chemical substance production and usage. Processor 100 is connected as needed (120, 140, 180, 300, 300′, etc.) to other various components (200, 500, 900, 600, 600′, 670, 670′, 10) to receive sensor input signals and send control signals. Computer processor 100 may be operatively coupled to a non-transitory storage device(s) (not shown) that stores executable instructions. The computer processor 100 may include a CPU(s) and/or a GPU(s) that reads instructions from the storage device and executes the instructions to perform functions and operations the instructions specify. In some embodiments, the computer processor 100 may comprise or consist of hardware such as a programmable or non-programmable gate array, an ASIC or any other suitable implementation comprising hardware and/or software. In some embodiments, processor 100 may be implemented as multiple processors which may, although not necessarily, be mutually connected or communicating and including an absence or any plurality of connection or communication means. Computer processor 100 receives operating power 120 from the battery 200, from which it may also receive sensory signals 140 and to which it may send control signals. Implementations may have connections beyond those specifically illustrated here, from computer processor 100 to other components. For example, computer processor 100 may be operatively coupled to numerous input sensors; numerous output devices such as actuators, displays and/or audio transducers; and digital communication devices such as buses, networks, a wireless or wired data transceivers, etc.

In some embodiments, battery 200 provides ancillary power to various components in addition to processor 100. Battery 200 is shown external to the reactor, although in many embodiments it may be internal to the reactor, such as if the RS is implemented as or includes a fuel cell, an alternator/generator, or possesses other electrical power generation capabilities, if present, to receive and maintain charge. In some embodiments, battery 200 can be supplemented or replaced by other power sources such as solar panels, fuel cells, generators, alternators, or any external power sources, etc. In embodiments, the system depicted in FIG. 11 can have connections from battery 200 and processor 100 to other components not shown in the Figure. In embodiments, a battery 200 can be included as an initial power source. A battery 200 can also be useful in remote locations; in situations where battery acquisition, maintenance, or replacement may be difficult; or in emergency and special situations. In embodiments, the system and/or its battery 200 can provide for being jump-started with manually operated, or other kinetic current sources, or with solar panels.

In an embodiment, an operator (and/or the computer processor 100) activates the system by setting an ignition switch (not shown) to “on”. Referring to FIG. 11, this action by the operator or computer processor 100 gates power from battery 200 to the other components as appropriate, which can include RAs 500, 900 (if present), the processor 100, and optionally the RS, for example in systems where the RS requires preparation in anticipation of fuel flow. Once started, processor 100 senses, monitors, coordinates, regulates, and controls, as necessary, the activity and interaction of all components. The RAs 500, 900 (if present) can be started under control of processor 100, with the appropriate environment being established for producing the desired chemical reactants, including as examples and without limitation: power, temperature, humidity, pressure, charge, and electromagnetic fields. If sensors and controls in the RAs 500, 900 (if present) are required, such signals can be transmitted through bus 300/300′ to and from the processor 100. Once ready, the RAs 500, 900 (if present) are operationally activated under control of processor 100, which thereafter senses, monitors, coordinates, regulates, and controls, RAs 500, 900 to ensure proper operation.

In an embodiment, the RAs 500 are activated to instantiate, or filter, or isolate, or extract, or nucleate, a chemical reactant useful as a fuel material, which can be atoms or molecules, such as hydrogen (H₂). The chemical reactant produced by the RAs 500 is/are collected by the conduit 600, optionally purified or separated, which can further process it in various ways (denoted by the chemical processor 670) as appropriate before it is delivered to the RS 10 through an intake port 750. The chemical processor 670 can include various aspects of conduit(s) 600 that may exist and be attached to processor 100 and battery 200. Similarly, RAs 900 in one embodiment can instantiate, or filter, or isolate, or extract, or nucleate, a chemical reactant useful as an oxidizing agent which can be atoms or molecules, such as oxygen (O₂). The chemical reactant emitted by the RAs 900 (1-M) (if present) is/are collected by the conduit 600′ which may process it in various ways (denoted by the chemical processor 670′) as appropriate before it is delivered to the RS 10 through its reactant intake 750′.

After an operation reacting the different chemical reactants takes place in the RS 10 with satisfactory completion, the computer 100 can conduct a proper close-down for the RAs 500, 900, conduits 600, 600′, processors 670, 670′, RS 10, battery 200, any other integrated equipment, and for itself 100. The satisfactory completion of the intended chemical reaction in the RS 10 can be determined in various ways depending on the particular specific embodiment. In certain embodiments, the completion can be signaled by the operator setting an ignition switch (not shown) to “off,” or can be signaled via some computer interaction or artificial intelligence decision, or can be signaled by parameters pertaining to the RS itself, such as the passage of time or the generation of heat or other energy, or can be signaled by the status of a storage unit or other non-reactive fuel sink, such as a storage tank reaching a full state.

The Figures that follow depict other use cases that exemplify the principles for the RAs and RSs as disclosed herein.

While the use of these methods and apparatuses for producing conventional chemical reactants (including but not limited to those disclosed herein) is especially advantageous, these methods and apparatuses also are capable of producing a wide variety of materials that can be economically harnessed in appropriate situations for reacting with other chemical substances, such as oxygen and other oxidizing agents described herein. Such chemical reactants produced by these methods and apparatuses include those elements such as calcium, sodium, lithium, and the like, which are so reactive in the natural environment that they are not encountered in their unbound, elemental state. Examples of such atypical fuels include, without limitation, alkali metals: Li (which may react, e.g., with O₂, H₂O, CO₂, N₂), Na, K, and the like; alkaline earth metals (Be, Mg, Ca, and the like); and those other elements and compounds that can be involved in exothermic reactions, such as Al, Fe, CaO, and the like, including for example but without limitation, those that can be made to undergo exothermic reactions, such as Al, Fe, CaO. While the reactions involving certain chemical reactants can take place via a redox mechanism using an oxidizing agent such as oxygen, the chemical reactants instantiated, or filtered, or isolated, or extracted, or nucleated, by these methods and apparatuses are not limited to those that undergo redox reactions.

Chemical reactants produced by the methods and apparatuses disclosed herein can also include oxidants (i.e., oxidizing agents), which can be used to react with reductants produced by the methods and apparatuses disclosed herein, or which can be isolated to be used for other purposes. The oxidants that can be instantiated, or filtered, or isolated, or extracted, or nucleated, by these methods and apparatuses include without limitation, atomic oxygen and oxygen species, hydrogen peroxide, water (which can exothermically oxidize alkali metals, alkaline earth metals, and the like, and can exothermically react with alkali metal oxides or alkaline earth metal oxides such as CaO), halogen molecules such as F₂, Cl₂, Br₂, and the like, and other reactive metals (e.g., metal oxides) or non-metals.

In embodiments, the invention particularly relates to the identification and collection of chemical reactants produced by the methods disclosed herein. In embodiments, reactors as described herein can produce and extract chemical feedstock substances for more complex chemical reactions, making them available for further processing.

Chemical reactants produced by the methods and apparatuses disclosed herein can be stored in various containers or other retaining mechanisms for use elsewhere. Such containers or retaining mechanisms (collectively, “retainers”) allow the chemical reactants thus produced to be stored for use elsewhere or at a later time. Retainers can include, without limitation, tanks or bottles (for fluids (preferably gases)), caves (for gases), bags, envelopes or boxes (for solids), conduits, or any other vessel or other structure that at least for a discernible period of time (whether short or long), either while in transit or statically, stores a quantity of the chemical reactant.

ii. Use Cases Involving Chemical Reactants: Calcium Oxide and Calcium Hydroxide Production

As described previously, a RA as disclosed herein can interface with a system within which a chemical reaction can take place, which chemical reaction utilizes the chemical reactant(s) produced by the RA. Such a system for utilizing chemical reactants to support chemical reactions can also be termed a “reaction system,” (RS) and it can comprise any type of apparatus or enclosure within which a chemical reaction takes place. In embodiments, elemental metals such as calcium and its derivatives (including oxides and hydroxides) can be produced. Such elemental metals include but are not limited to alkali metals (e.g., Li, Na, K, etc.) and alkaline earth metals (e.g., Ca, Ba, etc.).

Advantageously, using the apparatuses and methods of the invention, a RA can be used to produce a desired chemical reactant such as CaO without the calcination process and without producing CO₂ either by the calcination reaction of CaCO₃ or by the use of thermal energy derived from combustion of fuel sources that themselves produce CO₂. These processes therefore can eliminate 100% of the CO₂ attributed to calcination for production of CaO and Ca(OH)₂.

In an exemplary embodiment, calcium oxide (CaO) and calcium hydroxide (Ca(OH)₂ molecules can be produced using the methods and apparatus disclosed herein. A system incorporating RAs can directly instantiate, or filter, or isolate, or extract, or nucleate, entire CaO or Ca(OH)₂ molecules into a suitably non-reactive environment, for example into an atmosphere devoid of moisture, carbon dioxide, or carbon monoxide. If the size of the instantiated calcium crystals/particles is sufficiently small, the production thereof can be collected and immediately packaged into airtight containers, or can be conducted forward for additional processing, such as, for example, the production of “clinker” for cement or for other uses. Otherwise, when the produced particles are large, they can be crushed, ground, or milled to a convenient size.

In certain embodiments, a system comprising one or more RAs as described herein can produce the elemental metal (e.g., Ca) and react it with oxygen to yield a corresponding metal oxide (e.g., CaO). The system therefore can accomplish the production of elemental Ca, calcium oxide (CaO), or calcium hydroxide (Ca(OH)₂) by using one or more RAs as disclosed herein.

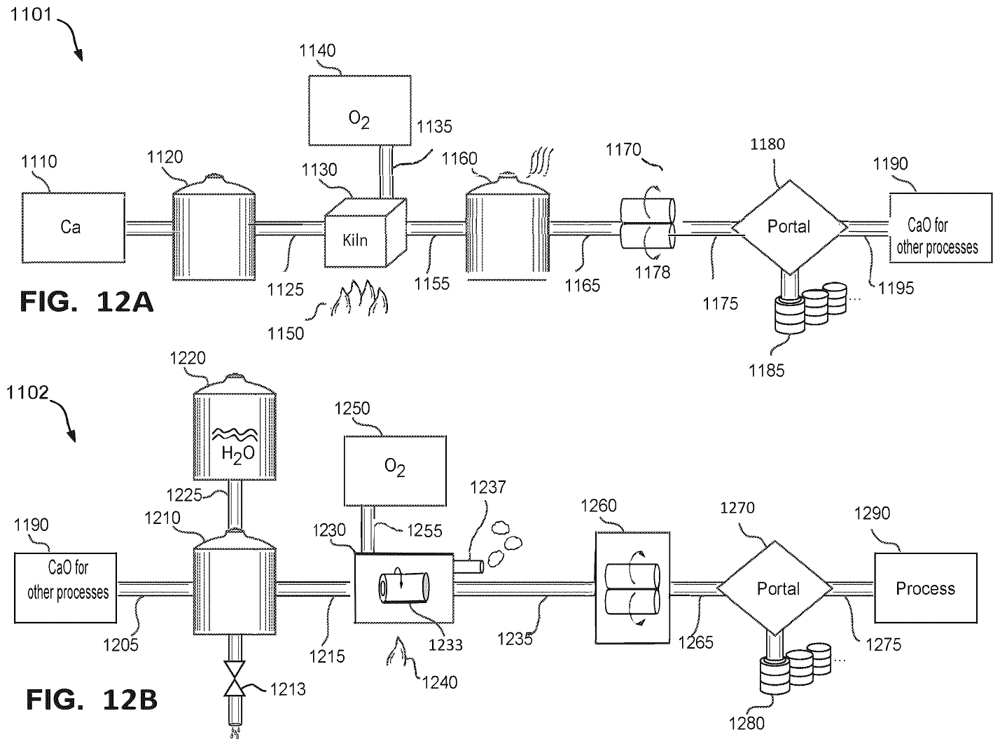

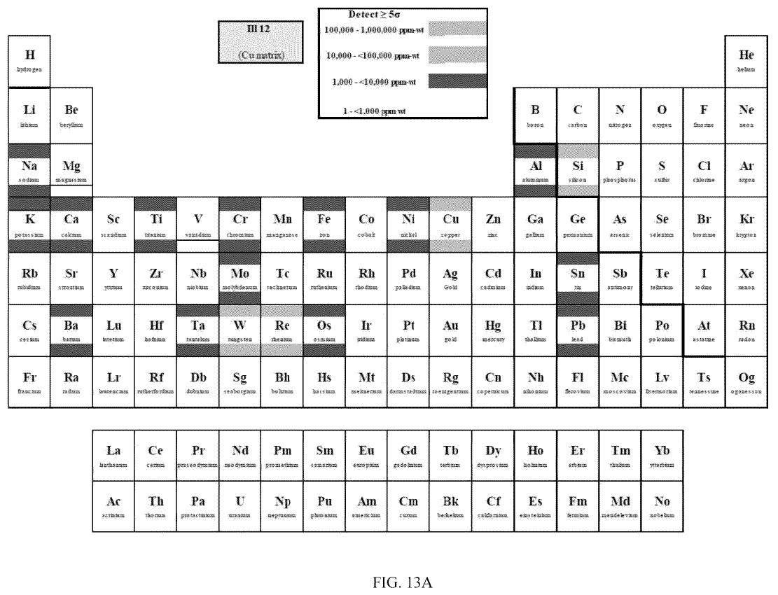

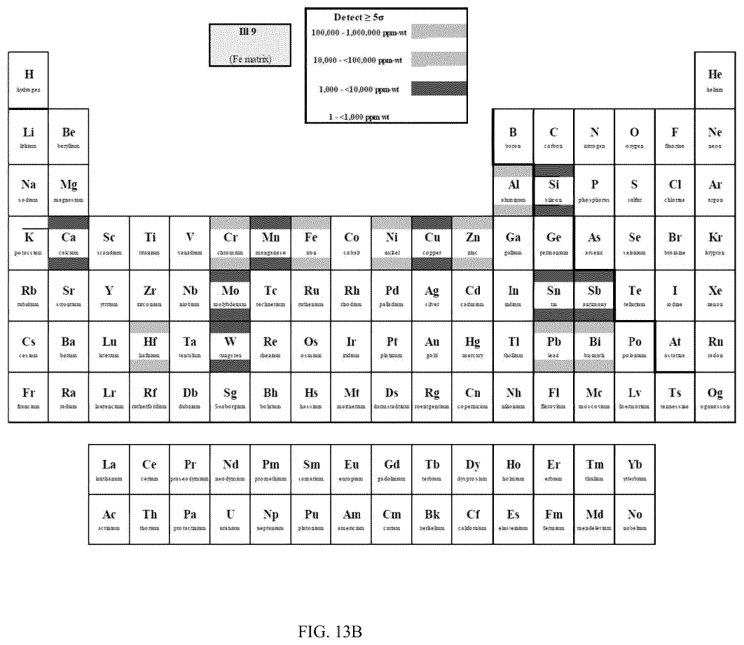

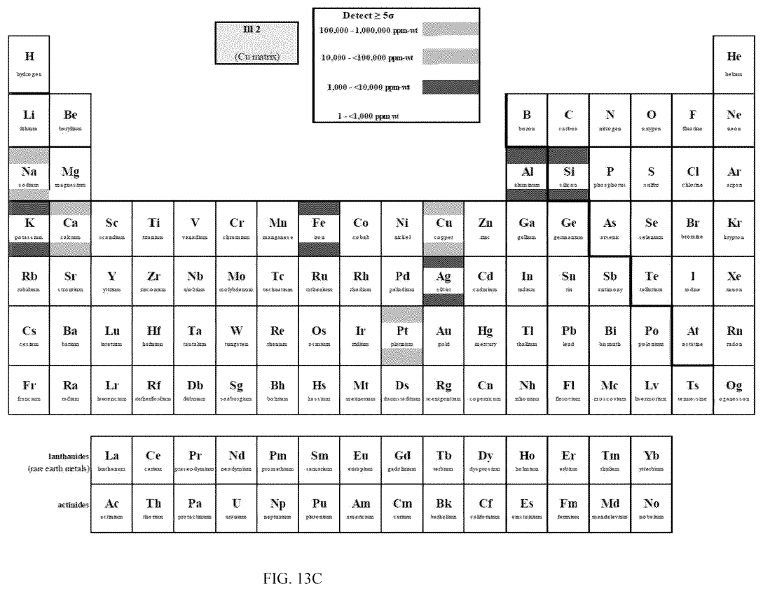

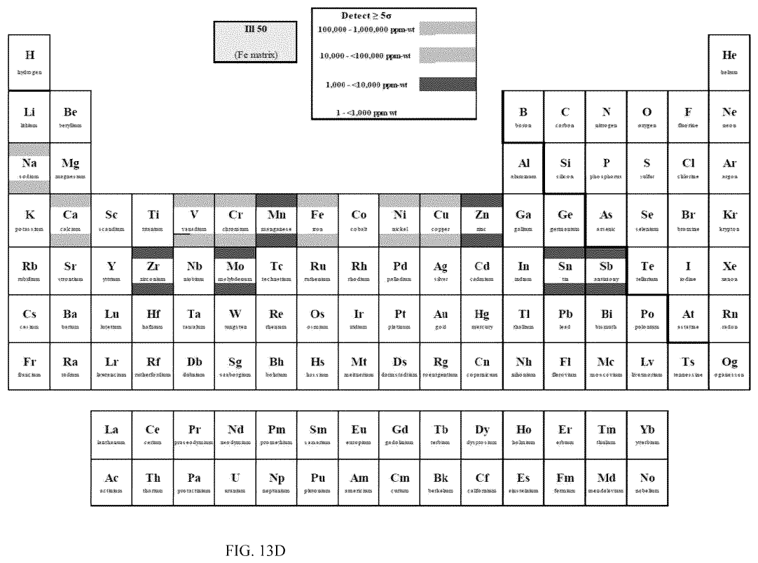

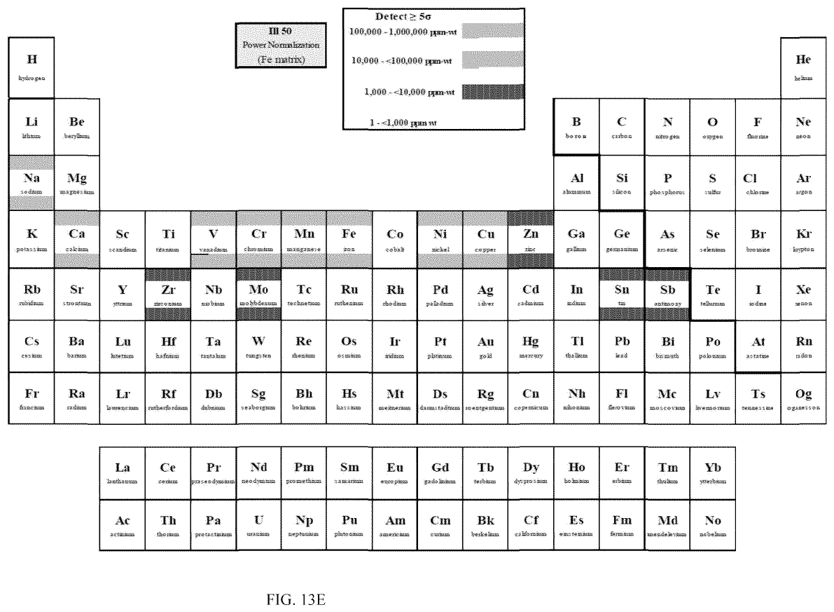

The system can typically include a unit for producing elemental calcium metal, an oxygen production or supply unit, and a first reaction unit which receives the produced elemental Ca metal and the oxygen, where the produced elemental Ca metal and oxygen react to form CaO. In some embodiments, the system can also include a water production or water supply unit, and a second reaction unit that receives CaO and water, where the CaO and water react to produce Ca(OH)₂. The system can also include a post-reaction processing unit, for example, to packaging the produced CaO or Ca(OH)₂. The system is typically configured such that the elemental Ca or CaO produced is not exposed to moisture or CO₂, except what is needed for Ca(OH)₂ production, CaO can react with water to yield the desired product. The unit for producing elemental calcium metal can include a RA configured to produce elemental Ca metal. The oxygen production unit can include a RA configured to produce O₂. The water production unit can include a RA configured to produce water (H₂O). Exemplary systems shown in FIGS. 12A and 12B are described in more detail herein.

The reaction of elemental calcium metal with oxygen using the inventive apparatuses can be performed under any suitable conditions known in the art. The oxygen is typically used in an amount sufficient to convert all elemental calcium metal into CaO, for example, in an amount of about 1-1000 or more molar equivalents of calcium. In some embodiments, the reaction can include oxidizing the calcium metal in the presence of oxygen, for example, with an initiation autoignition temperature of about 790±10° C.

In embodiments, the system for producing a calcium oxide or hydroxide comprises one or more RAs for producing the elemental calcium. In embodiments, the system further comprises a source of oxygen, which can be a separate assembly of one or more RAs for producing O₂. The system can comprise, optionally, a source of water, which can be a separate assembly of one or more RAs for producing H₂O. Once the calcium metal is produced as described above, and once the source of oxygen (either intrinsic to the system or extrinsic to the system) is operative, the reaction of elemental calcium metal with oxygen can be taken under any suitable conditions known in the art.

As described above, a RA can be used to directly instantiate, or filter, or isolate, or extract, or nucleate, elemental calcium and to directly instantiate, or filter, or isolate, or extract, or nucleate, oxygen gas; then these two chemical reactants can be reacted together in a vessel or other RS where the calcium metal can react with the oxygen gas, to oxidize the calcium metal in the presence of the oxygen. A high enough temperature (in embodiments, approximately 790±10° C.) autoignites the subsequent exothermic reaction for producing CaO that is shown in the following equation (EQ4):

$$2 Ca ( s ) + {O}_{2} ( g ) \to 2 CaO ( s ) + heat \qquad EQ4$$

As an alternative, the elemental calcium metal produced by a RA can react with any alternative source of oxygen gas, such as pure O₂ gas feed, to produce CaO.

Advantageously, the apparatuses and methods of the present invention can also be used to produce elemental calcium that can be used for other purposes. Calcium's highly reactive behavior prevents it from being found in its elemental state in nature, and most calcium used industrially is extracted by reduction from natural sources using calcination or electrolysis. The invention offers a pathway for obtaining calcium, whether it is to be used immediately to produce CaO or Ca(OH)₂, or whether it is to be used for other purposes.

The schematic diagram provided in FIG. 10 figuratively depicting the systems and processes of the invention can be used to illustrate the invention as applied to the production of CaO. As described above with reference to FIG. 10, a plurality of RAs, (RA-1, 12 and RA-2, 14) can produce the same or different substances, to be supplied to RS 10: for example, one of the RAs shown here can produce Ca while the other RA can produce O₂. These chemical reactants are conveyed into the RS 10, where the designated reaction takes place to produce CaO.

The present use case describes, in embodiments, the use of RAs such as RA-1 (12) and RA-2 (14) to instantiate, or filter, or isolate, or extract, or nucleate, Ca and O₂, with the RS then combining these two chemical reactants to yield the reaction product CaO. However, it is understood that RAs in accordance with the invention are capable of instantiating a desired chemical substance(s) or mixture of chemical substances, including but not limited to simple mono-elemental atoms and molecules (e.g., alkali metals such as Na, alkaline earth metals such as Ca, H₂, O₂, halogen molecules such as Cl₂, etc.), simple multi-elemental molecules comprising at least two elements (e.g., CO, NH₃ or H₂O₂, CaO, Ca(OH)₂, etc.), or complex multi-elemental molecules comprising at least two elements in various distinguished configurations (e.g., hydrocarbons, carbohydrates, alcohols, etc.). As depicted in FIG. 10, the RAs 12 and 14 can be coupled to any RS apparatus 10 that can immediately, or almost immediately, or at other timing, carry out chemical reactions between the chemical reactant produced by RA-1 and RA-2 to yield useful reaction products. The use case of instantiating Ca and O₂ to produce CaO provides an illustrative example of the principles of the invention.

The CaO solid resulting from this reaction can be immediately ground to a consistent powder, cither for use in subsequent reactions, or for storage in a protective environment. A protective environment can be any environment that prevents subsequent reactions for the CaO, for example, an airtight container, or an inert or non-reactive atmosphere that prevents the CaO from encountering other reactants. In embodiments, the finished CaO can be stored, conveyed, or maintained in a protective environment comprising a noble gas or other non-reactive milieu (such as nitrogen gas) to inhibit further chemical reaction with exposure to the moisture, vapors, carbon dioxide, etc. found in the ambient atmosphere. Of the noble gases (helium, neon, argon, krypton, xenon, and radon), krypton can be advantageous because it is heavy (making it easy to pump and manage) and because it avoids certain undesirable features of xenon and radon. In such an embodiment, the inert noble gas atmosphere can also be instantiated, or filtered, or isolated, or extracted, or nucleated, by a dedicated RA, although the selected noble gas or other non-reactive atmosphere can be obtained from any conventional source. In other embodiments, a non-reactive gas such as nitrogen gas can be used to produce the protective atmosphere for storing the CaO solid. In another embodiment, O₂ can be used to form the protective atmosphere for storing the CaO solid, since O₂ does not react further with CaO, and since the O₂ may already be available in the system, for example produced by the RA systems disclosed herein or otherwise obtained for oxidizing the Ca that has been produced by the RA systems of the invention.

Ca(OH)₂ can be formed from the inventive apparatuses by reacting CaO that is produced as described above with water. Water to react with CaO to produce Ca(OH)₂ can come from any source. In an embodiment, one or more RAs can be used to instantiate, or filter, or isolate, or extract, or nucleate, some or all of the necessary water. In embodiments, RAs can be used to produce water in various ways. In one embodiment, at least one RA can instantiate, or filter, or isolate, or extract, or nucleate, hydrogen, which can then be burned in the ambient atmosphere, with the resulting steam (H₂O) being captured, collected, cooled, and condensed to yield water. In embodiments, multiple RAs can be used separately to instantiate, or filter, or isolate, or extract, or nucleate, hydrogen and oxygen, with the instantiated hydrogen subsequently being combined with the instantiated oxygen to produce water. In this embodiment, water can be produced as steam, which can then be captured, collected, cooled and condensed to yield liquid water for subsequent reactions, such as to produce Ca(OH)₂ from the CaO instantiated using the techniques of the invention previously described. In yet another embodiment, a RA can be used to directly instantiate, or filter, or isolate, or extract, or nucleate, completed H₂O molecules. In certain embodiments, in which the production of CaO and Ca(OH)₂ takes place in proximity to other systems that produce steam or water as byproducts, the steam or water byproducts of these other systems can be captured, collected, cooled, and condensed to provide a water source for the hydration of CaO to form Ca(OH)₂.

In embodiments, Ca(OH)₂ produced as disclosed herein is dried and ground, while being protected from exposure to air; it is understood that Ca(OH)₂ spontaneously reacts with CO₂ such as exists in the atmosphere to revert to CaCO₃. In an embodiment, the Ca(OH)₂ can be prepared, dried, ground, and thereafter maintained in an atmosphere non-reactive with the calcium hydroxide, such as an atmosphere of pure oxygen which can be separately instantiated, or filtered, or isolated, or extracted, or nucleated, by RAs or obtained elsewhere; alternatively, the Ca(OH)₂ can be stored in air-tight drums until it is used.

FIG. 12A illustrates an exemplary embodiment of a system for producing CaO according to the invention. As shown in FIG. 12A, a system for producing CaO 1101 can include an integrated system of reactor assemblies and reactors, similar to the system depicted schematically in FIG. 11. In more detail, a Ca-instantiating system 1110 comprises one or more reactor assemblies (not shown) that instantiate, or filter, or isolate, or extract, or nucleate, elemental calcium using the processes and apparatuses of the invention as have been described above in more detail. The calcium instantiated, or filtered, or isolated, or extracted, or nucleated, by the Ca-instantiating system 1110 is transported through a conduit to be stored in a collection chamber 1120 until a large enough batch of instantiated elemental calcium has accumulated to allow the efficient combination of the instantiated calcium with the oxygen reactant that is being instantiated, or filtered, or isolated, or extracted, or nucleated, by the O₂-producing system 1140. While the process illustrated in FIG. 12A is described as a batch process, it is understood that other arrangements of the components of in the Ca-instantiating system can permit continuous process, and the collection chamber 1120 and similar components need not be used.

With reference to FIG. 12A, a conduit 1125 is briefly opened after sufficient instantiated calcium has been accumulated in the collection chamber 1120, allowing the passage of the calcium into the kiln 1130. After the batch has been moved into the kiln 1130, the conduit 1125 is closed, and conduit 1135 is opened, allowing O₂ that had been produced by the O_{2—} producing system 1140 to fill the kiln 1130 with sufficient O₂ to permit the oxidation of the calcium to form CaO. When the appropriate stoichiometric quantities of calcium and O₂ have entered the kiln 1130, the conduit 1135 is closed and the mixture of calcium and oxygen is ignited in the kiln 1130 by a heating element 1150, which supplies sufficient heat to the kiln's contents to autoignite the calcium (790±10° C.) and initiate the reaction of the calcium and the O₂. Although the heating element 1150 can be a conventional device for producing heat, in embodiments the heating element 1150 can produce heat using apparatuses and methods of the invention, such as are described in Atty. Docket Number 4319.3007 WO, entitled “Processes for Producing Reactant Substances for Thermal Devices,” by Fischer et al., filed even date herewith, for example, by combusting chemical reactants that have been produced using the instantiation methods disclosed herein. In an alternative continuous process, the batch method disclosed above can be replaced by a continuous process, with the conduit 1135 being left open to allow continuing admission of O₂, provided that the O₂-producing system 1140 is protected against backflow.

After the calcium has been oxidized to form CaO, the CaO can be allowed to cool in the kiln 1130, following which the outflow conduit 1155 is opened to permit the egress of the CaO from the kiln 1130 into the cooling chamber 1160. In the cooling chamber 1160 the CaO is cooled either actively or passively, until it reaches a temperature suitable for handling. At that point, the product conduit 1165 is opened, so that the CaO is conveyed to a processing system 1170 for further processing in order to convert it into desired products. In the depicted embodiment, the CaO is introduced into a mill 1178 that grinds the CaO into a usable powder form. Prior to the mill operation, the product conduit 1165 is closed to prevent backflow. After the CaO has been ground to appropriate product specifications, the export conduit 1175 is opened and the powdered CaO is discharged into a distribution portal 1180, and the export conduit 1175 is again closed. The distribution portal 1180 can direct the product through commercialization channels 1195 so it can be used for other industrial processes 1190, for example, to form clinker for Portland cement, to be used to synthesize gypsum, or to produce Ca(OH)₂. This last process is illustrated in more detail in FIG. 12B.

FIG. 12B illustrates an exemplary embodiment of a system for producing Ca(OH)₂ according to the invention. The system and processes illustrated in this Figure commence with the import of CaO that had been produced to be used in other industrial processes 1190, such as were shown in FIG. 12A. In the depicted embodiment, the CaO is advantageously produced using the instantiation steps in FIG. 12A; however, it is understood that CaO from other sources can be used in addition to or instead of the CaO produced by the invention. The CaO is the primary reactant for the formation of Ca(OH)₂. It is understood that the present invention to form Ca(OH)₂ requires that either the primary reactant CaO or the water used for its hydration, or both, be produced by the instantiation processes disclosed herein. Therefore, if CaO for forming Ca(OH)₂ is derived from conventional sources, the water must be produced by the inventive instantiation apparatuses and methods; conversely, if water for forming Ca(OH)₂ is derived from conventional sources, the CaO must be produced by the inventive instantiation apparatuses and methods.

As shown in FIG. 12B, a conduit 1205 is opened to allow a batch of the CaO to be moved into a hydration chamber 1210, where it will be hydrated to produce the desired product Ca(OH)₂. The process illustrated in this Figure is described as a batch process, but it is understood that a continuous process can be employed. In more detail, the conduit 1205 is closed after the CaO is directed into the hydration chamber 1210, and a water conduit 1225 is opened, allowing water from the water source 1220 to enter the hydration chamber 1210 in sufficient quantity to hydrate the CaO. As mentioned previously, any water supply can be used as the water source 1220, but advantageously water can be produced by the instantiation processes as described herein (not shown in this Figure). When adequate water has been provided for hydration, the water conduit 1225 is closed, allowing the CaO to react with the water to produce the Ca(OH)₂. After the reaction is complete, the valve 1213 is opened to drain excess water, and then closed. Conduit 1215 is opened, and the damp Ca(OH)₂ is moved into the drying oven 1230, following which the conduit 1215 is closed.

To remove residual dampness, heat is delivered at a modest temperature to the drying oven 1230 from a heat source 1240, with the drying oven 1230 being ventilated with dry gas devoid of CO₂, delivered from a gas source 1250 through a gas conduit 1255. Although heat source 1240 and gas source 1250 are not restricted, in embodiments, the dry gas source 1250 can produce oxygen (O₂) or other gases (e.g., nitrogen or any noble gases) as the drying gas using the instantiation apparatuses and methods of the invention; similarly, the heat source 1240 can produce heat using apparatuses and methods of the invention, for example, by combusting reactants produced using the instantiation methods disclosed herein. To facilitate drying, the drying oven 1230 can be equipped with mechanisms to stir, mix, or otherwise agitate the damp Ca(OH)₂ (a rotary mixer 1233 is shown in FIG. 12B). Optionally, the gas source 1250 and/or the conduit 1255 can include their own heaters (not shown) to warm the drying gas before it enters the drying oven. Moisture vapor resulting from the drying process can be emitted through vent 1237 in a way that prevents inflow of undesirable outside elements such as CO₂. After the contents of the drying oven 1230 are thoroughly dry, the outflow conduit 1235 is opened. This permits the Ca(OH)₂ to be moved to a mill 1260, following which the outflow conduit 1235 is closed. The mill 1260 grinds the Ca(OH)₂ to appropriate specifications, after which the export conduit 1265 is opened, allowing the Ca(OH)₂ to be delivered through a routing portal 1270, where it is packed and sealed in airtight containers 1280 to be stored or transported, or where it is directed through commercialization channels 1275 for other industrial processes 1290.

### Examples

### Example 1: Energy/Light Combed Activation (E/LC)

One hundred milligrams (100 mg) of powdered carbon were placed in a GG-EL graphite tubular reactor (15.875 mm) OD, with ID machined to ˜9 mm). This reactor was inserted into a reactor assembly FIG. 2A and then placed into a high vacuum oven for degassing according to the Degassing Procedure (See Profile 1 or Profile 2). After degassing, the reactor assembly is transferred to a test cell for processing. Research-grade Nitrogen (N₂) was delivered at 2 SLPM to purge the system for a minimum of 25 seconds or more. The gases were fed through the E/MEE in a horizontal and level gas line, as described above. During purging, gas sampling lines are also purged. TEDLAR® sealed bags, when used, are connected to the sampling lines during the purge cycle.

Referring to FIG. 1, the argon “KC” light 108 located in position 0 (vertical lamp orientation; 7.62 cm from inlet or entrance flange; at 180°; bulb tip pointing up 2.54 cm from the outer diameter of the gas line) was turned on at the onset while simultaneously energizing the power supply to 5 amps. This light was kept on for a minimum hold time of 9 sec. Next light 109 in position 1 (109; horizontal lamp orientation; 7.62 cm from inlet or entrance flange; at 180°; bulb tip facing exit plate; bulb glass base at the optical entrance; 5.08 cm, from the outer diameter of the gas line), a krypton light, was turned on and the power is increased to 10 amps on the power supply. This was held for 3 seconds, light 107, in position 1 (107; horizontal lamp orientation; at 0°; bulb tip at the optical exit facing the exit plate; 5.04 cm from the outer diameter of the gas line), a xenon light was turned on and held for 9 seconds and the power was increased to 15 amps. After these 3 lights have been sequentially turned on, the sealed TEDLAR® bags are opened for gas collection, and the amperage delivered to reactor was adjusted to 100 amps and held for a minimum of 30 seconds. Immediately after the power was increased, light 103 in position 1 (103; vertical lamp orientation; 7.62 cm from inlet or entrance flange; at 0°; bulb tip pointing down 2.54 cm from the outer diameter of the gas line), a neon light, was turned on.

Amperage harmonic patterning was then initiated on the reactor. With each amperage pattern (oscillation), the gases fed to the reactor can be treated by the same or different light sequence. In one embodiment of the experimental protocol, the amperage of the reactor was increased to 78.5 amps over 1 second, the high-end harmonic pattern point. The amperage of the reactor was then decreased to 38.5 amps over 9 seconds and held at 38.5 amps for 3 seconds. Immediately at the start of the 3 second hold, an argon light 122 in position 1 (122; horizontal lamp orientation; at 180°; bulb tip pointing towards entrance plate at the optical entrance; 5.04 cm from the outer diameter of the gas line) was turned on. After the 3 second hold, amperage to the reactor was then ramped up to 78.5 amps over 9 seconds with a 3 second hold upon reaching 78.5 amps before a downward ramp was initiated. The reactor amperage was decreased to 38.5 amps, over 9 seconds and then held for 3 seconds. Immediately at the start of the 3 second hold, light 103 (103), a neon light in position 1, was turned on. The reactor amperage was again ramped up to 78.5 amps over 9 seconds, held there for 3 seconds, and then again ramped down to 38.5 amps over 9 seconds. A long-wave ultraviolet lamp (104; horizontal lamp orientation; at 90°; bulb tip facing entrance plate at the optical entrance; 5.04 cm from the outer diameter of the gas line) in position 1 was turned on.

The reactor was again ramped up to 78.5 amps over 9 seconds, held for 3 seconds, then decreased to 38.5 amps over another 9 seconds. Next a short-wave ultraviolet lamp (105 horizontal lamp orientation; 7.62 cm from inlet or entrance flange; at 270°; bulb tip at the optical entrance and facing the entrance plate; 5.04 cm from the outer diameter of the gas line) in the E/MEE (position 1) E/MEE section light was turned on and held for 3 seconds. The reactor was again ramped up to 78.5 amps over 9 seconds and held for 3 seconds. After the 3 second hold, the reactor amperage was decreased to 38.5 amps over another 9 seconds. The reactor was then held at 38.5 amps for 3 seconds, before another ramp up to 78.5 amps over 9 seconds was initiated. At 3 seconds into this ramp, lamp 107, in position 1 (107) was turned on and held there for the remaining 6 seconds of the 9 second total ramp. The reactor was held for 3 seconds in this condition.

The lights were turned off simultaneously in the E/MEE section as follows: (103), (108), (106), (105) and (104) and the reactor was deenergized. The reactor was held at this state, with continuous gas flow for 27 seconds during which the TEDLAR® bags are closed and removed. All remaining lights were turned off and gas flow continues for 240 seconds.

### Example 2: Degassing Profile 1

One hundred milligrams (100 mg) of powdered carbon were placed in a graphite tubular reactor (15.875 mm) OD, with ID machined to ˜9 mm), as described above and loaded into a closed end system. After ten closed end set-ups have been completed, each individual unit was loaded into the degassing oven openings and all incoming and outgoing lines were connected to the closed end systems. Isolated each incoming line to each reactor while maintaining the outgoing lines in an open position. Started the vacuum system until the vacuum gauge reads at least 750 mmHg. Upon reaching 750 MmHg, closed all outgoing line valves from the closed end systems and secured the vacuum pump. Performed a 30-minute leak test of the system. After successfully passing the leak check, opened each incoming line to the closed end system one at a time at 0.4 slpm N₂. Once all incoming lines were open and the vacuum gauge reached a slight positive pressure, opened the outgoing gas line on the degassing oven. Started the degassing oven profile ramping from T_{amb} to 400° C. over 1 hour while maintaining N₂ flow. After the 1-hour ramp, maintained flow for an additional hour for temperature stabilization while maintaining gas flow. After the temperature stabilization was complete, secured all incoming gas flows and isolated the degassing oven vent line. Immediately started the vacuum pump and begin the degassing protocol. Maintained the temperature and vacuum for 12 hours. After the 12 hours, allowed the oven to cool prior to closed end unit removal.

### Example 3: Degassing Profile 2

One hundred milligrams (100 mg) of powdered carbon were placed in a graphite tubular reactor (15.875 mm) OD, with ID machined to ˜9 mm), as described above and loaded into a closed end system. After ten closed end set-ups have been completed, each individual unit was loaded into the degassing oven openings and connected all incoming and outgoing lines to the closed end systems. Isolated each incoming line to each reactor while maintaining the outgoing lines in an open position. Started the vacuum system until the vacuum gauge reads at least 750 mmHg. Upon reaching 750 MmHg, closed all outgoing line valves from the closed end systems and secured the vacuum pump. Performed a 30-minute leak test of the system. After successfully passing the leak check, opened each incoming line to the closed end system one at a time at 0.4 SLPM N₂. Once all incoming lines were open and the vacuum gauge reached a slight positive pressure, opened the gas outgoing gas line on the degassing oven. Started the degassing oven profile ramping from 200° C.±50° C. to 400° C. over 1 hour while maintaining N₂ flow. After the 1-hour ramp, maintained flow for an additional hour for temperature stabilization while maintaining gas flow. After the temperature stabilization was complete, secured all incoming gas flows and isolated the degassing oven vent line. Immediately started the vacuum pump and began the degassing protocol. Maintained the temperature and vacuum for 12 hours. After the 12 hours, allowed the oven to cool prior to closed end unit removal.

### Example 4: Gas Analysis

For the chemical analysis of gas samples in TEDLAR® bags, a test protocol was developed based on the standard test method established for internal gas analysis of hermetically sealed devices. Prior to sample measurement, system background was determined by following exact measurement protocol that is used for sample gas. For system background and sample, a fixed volume of gas was introduced to the Pfeiffer QMA 200M quadrupole mass spectrometer (QMS) system through a capillary. Through a capillary, a fixed volume of gas was introduced to the Pfeiffer QMA 200M quadrupole mass spectrometer (QMS) system. After sample gas introduction, the ion current for specific masses (same as masses analyzed for system background) were measured. During background and sample gas analyses total pressure of the QMS system was also recorded, allowing for correction of the measured ion current.

TABLE 2
Gases analyzed for the test method and
measured masses used in deconvolution.

| Gas | Masses used for deconvolution |
|---|---|
| 1. Hydrogen | 2, 18, 55, 57 |
| 2. Helium (3) | 2, 4 |
| 3. Helium (4) | 4 |
| 4. Methane | 14, 15 |
| 5. Water | 18, 32, 40 |
| 6. Neon (20) | 18, 20, 40 |
| 7. Neon (22) | 20 |
| 8. Nitrogen | 14 |
| 9. Carbon Monoxide | 14, 28 |
| 10. Oxygen | 32 |
| 11. Argon | 40, 41, 43 |
| 12. Carbon Dioxide | 44 |
| 13. Tot. HC and Org. | 55, 57 |
| 14. Fluorocarbons | 69 |
| 15. Ammonia | 17, 18 |
| 16. Krypton | 84 |
| 17. Xenon | 132 |

### Data Analysis:

Measurements of the ion current for each mass were corrected to the average of measured background contributions corrected for pressure difference. Subsequent to the background correction, individual corrected mass signals were averaged and corrected to a known gas standard to determine the percent volume of 17 gas species. All corrections were determined using nitrogen and nitrogen-hydrogen mixture reference gases analyzed to match selected process gas for test samples using the developed protocol based on the standard test method, in accordance with Military Standard (MIL-STD-883) Test Method 1018, Microcircuits, Revision L, FSC/Area: 5962 (DLA, 16 Sep. 2019). Results below: 1%=10,000 ppm, Volume values for gas blanks and samples were produced using the developed gas analysis test method and validated using a gas mixture standard of 99.98% nitrogen and 0.02% hydrogen. All analytical performed by EAG Laboratories, Liverpool, NY using standard TEDLAR® bag gas sampling protocols and specified mass spectrometry methods.
Mass Analyzer: Quadrupole mass spectrometer (Pfeiffer QMA 200M)
Measurement mode: Analog scan for selected masses
No. of channels used: 64
Mass resolution: Unit resolution
Maximum detectable concentration: 100%
Minimum detectable concentration: 1 ppb
Background vacuum: <2×10⁻⁶ Torr

### Results:

Protocol 1:

| Gases Analyzed (Vol %) | III. 1 | III. 2 | III. 3 | III. 4 | III. 5 |
|---|---|---|---|---|---|
| Hydrogen | 0.7678 | 0.2405 | 0 | 0 | 0.0162 |
| Helium (4) | 0.1923 | 0.2963 | 0.1928 | 0.5476 | 0.1254 |
| Methane (CH₄) | 0 | 0 | 0 | 0 | 0 |
| Water (H₂O) | 0.4054 | 1.0773 | 0 | 0 | 0 |
| Neon (20) | 0.036 | 0.03 | 0.0417 | 0.1789 | 0.0345 |
| Neon (22) | 0.0036 | 0.003 | 0.0042 | 0.0179 | 0.0035 |
| Nitrogen | 95.276 | 89.3705 | 99.347 | 88.2306 | 99.6251 |
| Carbon Monoxide (CO) | 0 | 0 | 0 | 0 | 0 |
| Oxygen | 3.1604 | 8.5606 | 0.3796 | 10.945 | 0.1826 |
| Argon | 0.0676 | 0.349 | 0.0003 | 0.08 | 0 |
| Carbon Dioxide (CO₂) | 0.0138 | 0 | 0 | 0 | 0 |
| Total Hydrocarbons and | 0.0269 | 0 | 0.0175 | 0 | 0 |
| Organics | | | | | |
| Fluorocarbons | 0.0261 | 0.0417 | 0.0162 | 0 | 0.0127 |
| Ammonia (NH₃) | 0 | 0.031 | 0 | 0 | 0 |
| Krypton | 0.0242 | 0 | 0 | 0 | 0 |
| Xenon | 0 | 0 | 0 | 0 | 0 |

| Gases Analyzed (Vol %) | III. 6 | III 7. | III. 8 | III. 9 |
|---|---|---|---|---|
| Hydrogen | 1.027 | 0 | 0 | 4.0494 |
| Helium (4) | 0.364 | 2.6033 | 0.2145 | 25.118 |
| Methane (CH₄) | 0 | 0 | 0 | 0 |
| Water (H₂O) | 0 | 0 | 0 | 0 |
| Neon (20) | 0.1093 | 0.4736 | 0.0308 | 5.6369 |
| Neon (22) | 0.0109 | 0.0474 | 0.0031 | 0.5637 |
| Nitrogen | 97.1911 | 94.6204 | 95.9834 | 56.538 |
| Carbon Monoxide (CO) | 0 | 0 | 0 | 0 |
| Oxygen | 1.2975 | 2.2553 | 3.7604 | 4.1726 |
| Argon | 0 | 0 | 0.0078 | 0 |
| Carbon Dioxide (CO₂) | 0 | 0 | 0 | 0 |
| Total Hydrocarbons and | 0 | 0 | 0 | 1.0654 |
| Organics | | | | |
| Fluorocarbons | 0 | 0 | 0 | 1.9565 |
| Ammonia (NH₃) | 0 | 0 | 0 | 0 |
| Krypton | 0 | 0 | 0 | 0.8997 |
| Xenon | 0 | 0 | 0 | 0 |

Protocol 2:

| Gases | | | | | | |
|---|---|---|---|---|---|---|
| Analyzed | | | | | | |
| (Vol. %) | Ill. 10 | Ill. 11 | Ill. 12 | Ill. 13 | Ill. 14 | Ill. 15 |
| Hydrogen | 0 | 1.0428 | 1.3437 | 0 | 1.6249 | 1.7941 |
| Helium (4) | 0.4679 | 0.3492 | 0.4409 | 0.8074 | 0.4888 | 0.6406 |
| Methane (CH₄) | 0 | 0 | 0 | 0 | 0 | 0 |
| Water (H₂O) | 0 | 2.3924 | 3.1436 | 0 | 4.4032 | 2.4182 |
| Neon (20) | 0.1598 | 0 | 0 | 0 | 0 | 0 |
| Neon (22) | 0.016 | 0 | 0 | 0 | 0 | 0 |
| Nitrogen | 76.7986 | 79.9798 | 94.2126 | 51.1046 | 92.2167 | 75.6209 |
| Carbon | 0 | 0 | 0 | 0 | 0 | 0 |
| Monoxide | | | | | | |
| (CO) | | | | | | |
| Oxygen | 22.079 | 15.565 | 0.8348 | 48.088 | 1.239 | 18.7733 |
| Argon | 0.4639 | 0.5717 | 0 | 0 | 0 | 0.721 |
| Carbon | 0 | 0.0991 | 0.0244 | 0 | 0.0274 | 0.0319 |
| Dioxide | | | | | | |
| (CO₂) | | | | | | |
| Total | 0 | 0 | 0 | 0 | 0 | 0 |
| Hydrocarbons | | | | | | |
| and Organics | | | | | | |
| Fluorocarbons | 0.0147 | 0 | 0 | 0 | 0 | 0 |
| Ammonia | 0 | 0 | 0 | 0 | 0 | 0 |
| (NH₃) | | | | | | |
| Krypton | 0 | 0 | 0 | 0 | 0 | 0 |
| Xenon | 0 | 0 | 0 | 0 | 0 | 0 |

Standard (Nitrogen):

| | Vol % Standard |
|---|---|
| | 99.98 vol % N₂/ |
| Gases Analyzed | 200 ppm H₂ |
| Hydrogen | 0.0223 |
| Helium (3) | 0.0000 |
| Helium (4) | 0.0000 |
| Methane (CH₄) | 0.0000 |
| Water (H₂O) | 0.0000 |
| Neon (20) | 0.0000 |
| Neon (22) | 0.0000 |
| Nitrogen | 99.9777 |
| Carbon Monoxide (CO) | 0.0000 |
| Oxygen | 0.0000 |
| Argon | 0.0000 |
| Carbon Dioxide (CO₂) | 0.0000 |
| Total Hydrocarbons | 0.0000 |
| and Organics | |
| Fluorocarbons | 0.0000 |
| Ammonia (NH₃) | 0.0000 |
| Krypton | 0.0000 |
| Xenon | 0.0000 |

### Example 5: Production of CaO

To produce 1000 parts (by mass) of CaO:

At least one RA configured to instantiate calcium can be used to instantiate 714.7 parts Ca and collect it in a closed heat-resistant non-reactive vessel. At least one RA configured to instantiate oxygen can be used to instantiate at least 285.3 parts O₂ and introduce it into the vessel as the temperature of the Ca is raised to above the autoignition temperature of Ca, about 790±10° C. under atmospheric conditions. Alternate ignition sources or conditions may be employed to sustain the reaction at lower temperatures if desired. The oxygen instantiated is typically in an amount sufficient to convert all elemental calcium metal into CaO, for example, in an amount of about 1-1000 or more molar equivalents of calcium. Once this exothermic reaction is initiated, the Ca can burn to completion, assuming that the O₂ is supplied in a sufficiently timely manner to sustain the stoichiometric reaction. This results in the production of pure CaO.

The activating heat can be supplied from any source. Other sources of heat using the inventions disclosed herein can be advantageously employed, such as are described in Atty. Docket Number 4319.3007WO, entitled “Processes for Producing Reactant Substances for Thermal Devices,” by Fischer et al., filed even date herewith. CaO thus produced is collected in an air-tight container: once instantiated, or filtered, or isolated, or extracted, or nucleated, neither calcium nor CaO should be exposed to water or CO₂ if the integrity and yield of the CaO product is to be maintained.

After the CaO has cooled sufficiently, it can be ground. After being ground, the CaO is suitable for further uses. It can therefore be packaged (e.g., loaded and sealed into airtight containers for storage or transport) and it can be used in a subsequent chemical process, such as to produce clinker for Portland cement, to be combined with sulfur-containing reactants to produce gypsum, or to act as a feedstock in the production of calcium hydroxide.

### Example 6: Production of Ca(OH)2

To produce 1000 parts (by mass) of Ca(OH)₂:

At least one RA configured to instantiate calcium can be used to instantiate 540.5 parts Ca and collect it in a closed heat-resistant non-reactive vessel. Water can be introduced into the reactor at temperatures at or above room temperature, converting the calcium-to-calcium hydroxide, and liberating hydrogen via the reaction:

Ca(s)+2H₂O(g)→Ca(OH)₂(s or aq)+H₂(g)(exothermic reaction)

The water addition is typically in an amount sufficient to convert all elemental calcium metal into Ca(OH)₂, for example, in an amount of about 2-1000 or more molar equivalents of calcium. Once this exothermic reaction is initiated, the Ca can react to completion, with water being supplied in a sufficiently timely manner to sustain the stoichiometric reaction, while moderating the liberation of heat. This results in the production of slaked lime, Ca(OH)₂. The liberated hydrogen can be recovered for further use as product or vented.

Calcium hydroxide, Ca(OH)₂ thus produced is extracted and recovered in its solid form as a powder or dissolved in water to form milk of lime. Note that the dissolution of calcium hydroxide in water is also an exothermic process; lower water temperatures enhance solubility. The recovered calcium hydroxide is suitable for all industrial uses including construction, sewage treatment, paper production, agriculture, and food processing. The high purity of Ca(OH)₂ produced via this method is particularly suited for food processing applications.

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference.

While this invention has been particularly shown and described with references to preferred embodiments thereof, it will be understood by those skilled in the art that various changes in form and details may be made therein without departing from the scope of the invention encompassed by the appended claims. Additionally, while the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. Numerical values where presented in the specification and claims are understood to be approximate values (e.g., approximately or about) as would be determined by the person of ordinary skill in the art in the context of the value. For example, a stated value can be understood to mean within 10% of the stated value, unless the person of ordinary skill in the art would understand otherwise, such as a value that must be an integer.

1. A process for producing a chemical reactant comprising the steps of:
(a) adding a feed gas to an electromagnetic embedding apparatus:
(b) exposing the feed gas to at least one E/MEE light source;
(c) directing the feed gas from step (b) to a reactor assembly comprising:
A gas inlet and one or more gas outlets;
A reactor chamber containing a nanoporous carbon disposed within a cup and, optionally, covered with a cap;
A first porous frit defining a floor of the reactor chamber disposed within the cup,
A second porous frit defining the ceiling of the reactor chamber; wherein each porous frit has a porosity that is sufficient to allow a gas to permeate into the reactor chamber;
A reactor head space disposed above the reactor chamber; and
At least one RA coil surrounding the reactor chamber and/or reactor head space operably connected to a power supply, wherein the computer processing unit is configured to control the power supply to the RA coil;
(d) powering each RA to a first electromagnetic energy level;
(e) subjecting the nanoporous carbon powder to harmonic patterning to instantiate a product gas comprising the chemical reactant;
(f) collecting the product gas comprising the chemical reactant; and
(g) isolating the chemical reactant from the product gas, wherein the chemical reactant comprises calcium.

2. The process of claim 1, wherein the feed gas comprises nitrogen.

3. (canceled)

4. (canceled)

5. The process of claim 1, wherein:
(a) the electromagnetic embedding apparatus comprises at least 5 E/MEE pencil lamps located along a gas line containing the feed gas;
(b) each E/MEE pencil lamp is independently placed such that its longitudinal axis is (i) parallel to the internal gas line, (ii) disposed radially in a vertical plane to the internal gas line, or (iii) perpendicular to the plane created along the longitudinal axis of the internal gas line or along the vertical axis of the internal gas line; and
(c) each E/MEE pencil lamp is independently affixed to one or more pivots that permit rotation between about 0 and 360 degrees with respect to the x, y, and/or z axis wherein (i) the x-axis is defined as the axis parallel to the gas line and its vertical plane, (ii) the y-axis defining the axis perpendicular to the gas line and parallel to its horizontal plane, and (iii) the z-axis is defined as the axis perpendicular to the gas line and parallel to its vertical plane.

6. The process of claim 1, wherein the reactor assembly further comprises a pole disposed below the reactor chamber and above the gas inlet.

7. (canceled)

8. (canceled)

9. (canceled)

10. The process of claim 1, wherein the cup is composed of graphite.

11. The process of claim 1, wherein the cap is composed of graphite, platinum, palladium or ruthenium.

12. (canceled)

13. The process of claim 1, wherein the product gas comprises at least about 1% vol. of the chemical reactant.

14. A chemical reactant produced by a process of claim 1.

15. A process for producing a chemical reactant comprising the steps of:
(a) Adding a feed gas to an electromagnetic embedding apparatus comprising:
a gas line containing the feed gas;
at least one E/MEE pencil lamp positioned below the gas line, at least one E/MEE pencil lamp positioned above the gas line and at least one E/MEE pencil lamp positioned to the side of the gas line, wherein each E/MEE pencil lamp is independently rotatably mounted, located along the length of the gas line;
a power source operably connected to each pencil lamp; and
a central processing unit configured to independently control powering each E/MEE pencil lamp and a rotation position of each E/MEE pencil lamp;
(b) powering each pencil lamp, thereby subjecting the feed gas to electromagnetic radiation; optionally rotating one or more lamps;
(c) directing the feed gas from step (b) to a reactor assembly comprising:
a gas inlet and one or more gas outlets;
a reactor chamber containing a nanoporous carbon disposed within a cup and, optionally, covered with a cap;
a first porous frit defining a floor of the reactor chamber disposed within the cup,
a second porous frit defining the ceiling of the reactor chamber and disposed below the cap; wherein each porous frit has a porosity that is sufficient to allow a gas to permeate into the reactor chamber and contain a nanoporous carbon;
a reactor head space disposed above the reactor cap;
at least one RA coil surrounding the reactor chamber and/or reactor head space operably connected to a power supply, wherein the computer processing unit is configured to control the power supply to the RA coil;
(d) powering each RA to a first electromagnetic energy level;
(e) subjecting the nanoporous carbon powder to harmonic patterning to instantiate product compositions; and
(f) collecting the chemical reactant from the product compositions, wherein the chemical reactant comprises calcium.

16. A chemical reactant produced by a process of claim 15.

17. A method of producing calcium oxide comprising:
(a) providing a set of one or more RAs, wherein the set of one or more RAs is configured to instantiate elemental calcium;
(b) instantiating elemental calcium in the set of one or more RAs; and
(c) directing the elemental calcium to react with oxygen, thereby producing the calcium oxide.

18. (canceled)

19. The method of claim 17, wherein the oxygen is produced from an auxiliary set of one or more RAs configured to produce oxygen.

20. The method of claim 17, wherein the oxygen is obtained from ambient atmosphere.

21. (canceled)

22. (canceled)

23. A method of producing calcium hydroxide, comprising:
(a) providing a set of one or more RAs, wherein the set of one or more RAs is configured to instantiate elemental calcium;
(b) instantiating elemental calcium in the set of one or more RAs;
(c) directing the elemental calcium to react with oxygen, thereby producing the calcium oxide; and
(d) hydrating the calcium oxide by exposing it to H₂O, thereby producing calcium hydroxide.

24. The method of claim 23, wherein the oxygen is produced by a second set of RAs.

25. The method of claim 23, wherein the H₂O is generated by reacting hydrogen produced by a third set of one or more RAs in combination with oxygen to form the H₂O.

26. The method of claim 25, wherein the oxygen for forming the H₂O is produced by a fourth set of RAs, and wherein the oxygen for forming the calcium oxide is produced by the second set of RAs.

27. A system for a producing a chemical reaction, comprising:
(a) at least one RA that instantiates a substance, wherein the substance is calcium; and
(b) a conduit in fluid communication with the at least one RA and a RS, wherein the conduit delivers the substance from the at least one RA into the RS, and wherein the RS supports the chemical reaction that consumes at least a portion of the substance.

28. (canceled)

29. The system of claim 28, further comprising an auxiliary RA that instantiates a reactant capable of reacting with the substance; and a second conduit in fluid communication with the auxiliary RA and the RS that delivers the reactant from the auxiliary RA into the RS, wherein the reactant within the RS interacts with the substance to produce the chemical reaction.

30. The system of claim 29, wherein the reactant comprises oxygen or consists essentially of oxygen.
